(19) United States
(12) Patent Application Publication
(10) Pub. No.: US 2024/0317255 A1
(43) Pub. Date: Sep. 26, 2024

(54) PLANNING SYSTEMS FOR AUTONOMOUS VEHICLES

(71) Applicant: GM Cruise Holdings LLC, San Francisco, CA (US)

(72) Inventors: Anisha Mocherla, Chicago, IL (US); Enrique Fernandez Gonzalez, San Francisco, CA (US); Michael Rusignola, Burlingame, CA (US); Joseph Lowman, San Francisco, CA (US); Allen Tang, Millbrae, CA (US); Andrew Robinson, San Francisco, CA (US); Xiaoyu Zhou, San Francisco, CA (US)

(21) Appl. No.: 18/187,546

(22) Filed: Mar. 21, 2023

(51) Int. Cl. B60W 60/00; B60W 50/04

(52) U.S. Cl. CPC B60W 60/001; B60W 50/045; B60W 2552/53; B60W 2554/80

(57) ABSTRACT

Systems and techniques are provided for using different planners for autonomous driving. An example method can include determining, based on sensor data from one or more sensors of an autonomous vehicle (AV), a maneuver to be performed by the AV according to one or more parameters that deviate from one or more restrictions of a first planner being used by the AV to navigate a scene; identifying a second planner of the AV that supports the one or more parameters that deviate from the one or more restrictions of the first planner; determining a state of the AV selected to trigger a switch from the first planner to the second planner; maneuvering the AV using the first planner until the state of the AV is satisfied; and in response to determining that the state of the AV is satisfied, autonomously switching from the first planner to the second planner.

### TECHNICAL FIELD

The present disclosure generally relates to using planners for autonomous driving. For example, aspects of the present disclosure relate to systems and techniques for implementing different planners for autonomous driving and automatically switching between planners used for different scenarios and/or use cases.

### BACKGROUND

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle navigation and routing operations, according to some examples of the present disclosure;

FIG. 2 is a diagram illustrating an example planning system with multiple planners implemented by an autonomous vehicle to perform various planning operations, according to some examples of the present disclosure;

FIG. 3A is a diagram illustrating an example use case for implementing a specialized planner of an autonomous vehicle to perform a maneuver in an example scene, according to some examples of the present disclosure;

FIG. 3B is a diagram illustrating another example use case for implementing a specialized planner of an autonomous vehicle to park the autonomous vehicle in a scene, according to some examples of the present disclosure;

FIG. 4 illustrates an example timeline for switching planners implemented by an autonomous vehicle, according to some examples of the present disclosure;

FIG. 5 is a flowchart illustrating an example process for implementing different planners for autonomous driving, according to some examples of the present disclosure; and

FIG. 6 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, an inertial measurement unit (IMU), and/or an acoustic sensor (e.g., sound navigation and ranging (SONAR), microphone, etc.), global navigation satellite system (GNSS) and/or global positioning system (GPS) receiver, amongst others. The AVs can use the various sensors to collect data and measurements that the AVs can use for AV operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc. The sensors can provide the data and measurements to an internal computing system of the autonomous vehicle, which can use the data and measurements to control a mechanical system of the autonomous vehicle, such as a vehicle propulsion system, a braking system, and/or a steering system, for example.

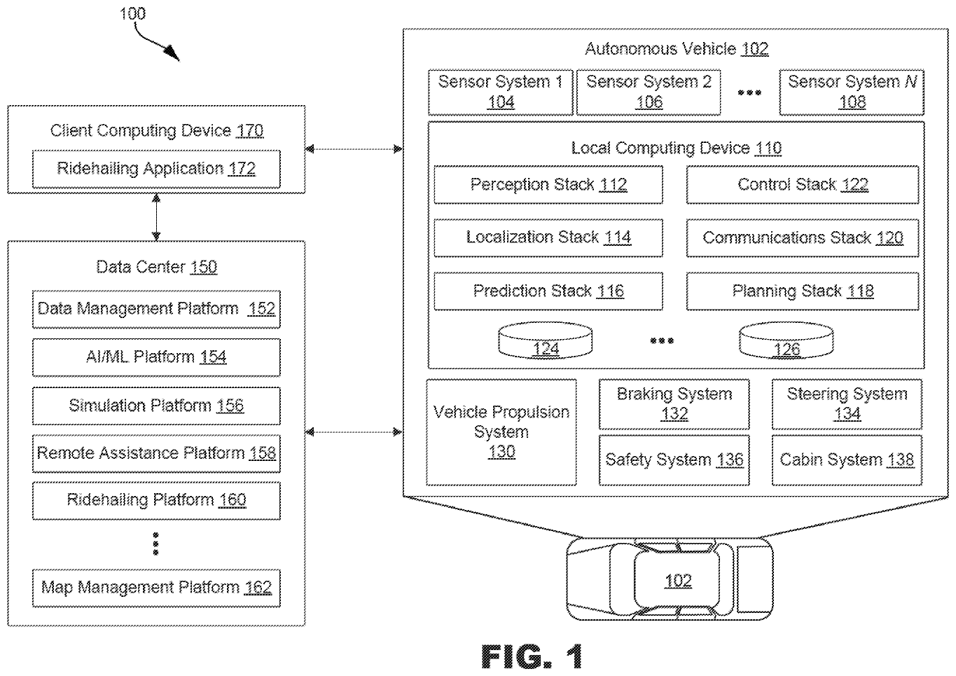

An AV can implement a planner system (e.g., a planner software, a planner model or algorithm, a planner service, a planner stack, etc.) to determine how to maneuver or operate the AV safely and efficiently in its environment. The planner system, such as the planning stack 118 described below with respect to FIG. 1, can be configured to obtain inputs from other systems of the AV such as, for example and without limitation, a perception system (e.g., perception stack 112 described below with respect to FIG. 1), a localization system (e.g., localization stack 114 described below with respect to FIG. 1), a prediction system (e.g., prediction stack 116 described below with respect to FIG. 1), and/or one or more other data sources (e.g., one or more databases such as AV operational database 124 and/or HD geospatial database 126 described below with respect to FIG. 1, a map, the Internet, etc.), and use the inputs to determine mechanical operations for the AV 102 to perform to meet any road conditions and events experienced by the AV.

For example, the planning system can use such inputs to determine mechanical operations for the AV to perform such as traveling along a lane or road at a specified speed and/or a specified rate of acceleration, turning on a specific blinker of the AV (e.g., a left blinker, a right blinker, etc.), decelerating the AV (e.g., to stop, to lower a speed of the AV prior to turning, to address certain road conditions, to avoid exceeding a maximum speed, etc.), performing a turn maneuver, stopping, etc. Non-limiting examples of the inputs used by the planning system can include map data, user inputs, and information about the pose and/or location of the AV, the speed of the AV, the direction of the AV, road geometries, objects sharing the road with the AV (e.g., pedestrians, bicycles, vehicles, trains, traffic lights, lanes, road markings, cones, barriers, etc.), any events occurring during a trip (e.g., accidents, behaviors and/or operations of emergency vehicles, street closures, occlusions, vehicles stopped on the road, maneuvers of other vehicles, etc.), semantic scene elements (e.g., lanes, intersections, sidewalks, crosswalks, center lines, stop areas, bus stops, etc.), traffic rules and other safety standards or practices for the road, and/or tracked objects.

Typically, the planning system used by an AV to navigate largely relies on information about lanes in a road that the AV and other vehicles can use to travel. For example, the planning system uses by an AV to navigate may largely rely on map data, semantic data, and/or perception data (e.g., elements in a scene perceived (e.g., detected and/or recognized) based on sensor data) identifying lanes on the road, the boundaries of lanes on the road, and/or other information about the lanes (e.g., lane directionality, lane rules, etc.). The planning system can use such information to navigate the AV on an appropriate lane according to traffic rules for that lane. Thus, the planning system can be very effective at navigating an AV in scenes with defines lanes by using, among other things, information about the lanes in the scenes. Moreover, the planning system typically implements certain parameters to ensure that the AV complies with applicable traffic rules and standards and satisfies safety metrics. For example, the planning system can implement rules and/or restrictions specifying a minimum collision buffer (e.g., a minimum distance between the AV and other vehicles ahead, behind, and/or adjacent to the AV), a minimum distance between the AV and other semantic elements (e.g., a construction zone, a parked or double-parked vehicle, a stalled vehicle, a stopped vehicle, a pedestrian, a bicycle and/or motorcycle, an intersection, a crosswalk, etc.), restrictions for merging, restrictions for maneuvering through an intersection and/or a crosswalk, etc.

Given the planning system's reliance on lanes and lane boundaries as well as configured parameters specifying applicable traffic rules and restrictions, the AV (e.g., and the planning system) can have difficulty navigating environments that do not have defined lanes and/or lacking certain (or any) rules and/or restrictions, or performing certain maneuvers where the AV may need to implement or follow certain parameters that deviate from preconfigured rules and/or restrictions. For example, the planning system of an AV may have difficulty navigating the AV in a garage or a construction zone that may not have defined or clearly-defined lanes and/or where the AV may need to deviate from pre-configured restrictions such as collision buffer restrictions (e.g., where the AV may need to reach or maintain a shorter distance to other vehicles in the garage (e.g., a vehicle ahead of the AV, a vehicle behind the AV, a vehicle adjacent to the AV, a parked vehicle, etc.), pedestrians in the garage, and/or objects in the garage). As another example, the planning system of an AV may have difficulty performing a maneuver where the AV may need to follow a path having a certain curvature (e.g., a curvature above a threshold), achieve a certain pose, and/or otherwise deviate from preconfigured restrictions such as, for example, a parking maneuver, a merge maneuver, a maneuver to navigate a cul-de-sac.

In some cases, the planner system may have difficulty autonomously navigating an AV in scenarios where the AV needs to deviate from a predetermined route in an environment and/or accommodate certain dynamic conditions and/or events. For example, if an AV needs to navigate a parking lot or a grassy area used for parking for an event, the planning system of the AV may have difficulty navigating the AV in such scenarios, as they may lack lanes (and lane boundaries) and/or may have traffic conditions or requirements that deviate from certain preconfigured rules and/or restrictions used by the planning system to navigate the AV in other environments. As another example, the planning system of an AV may have difficulty navigating the AV in an area where the AV may be unable to rely on lane markings such as areas that are covered in snow such that the snow obstructs the visibility of any lane markings in the area.

Systems, apparatuses, processes (also referred to as methods), and computer-readable media (collectively referred to as “systems and techniques”) are described herein for implementing different planners for autonomous driving. In some examples, the systems and techniques described herein can be used to implement different planners for autonomous driving and automatically switching between planners used for different scenarios and/or use cases. For example, the systems and techniques described herein can be used to implement a navigation planner used by an AV to navigate in certain scenes and a specialized planner used for other scenes and/or scenarios, and autonomously switching between the navigation planner and the specialized planner (and/or vice versa) in an intelligent manner (and/or as needed).

In some examples, the specialized planner can include a planner used by the AV to navigate in certain scenes where the AV may not rely on certain scene elements that are otherwise used by the navigation planner to navigate, such as lanes and lane boundaries. In other examples, the specialized planner can additionally or alternatively be used by the AV to perform certain maneuvers that may involve deviating from certain parameters (e.g., rules, restrictions, behaviors, etc.) implemented by the navigation planner. To illustrate, the AV may implement the specialized planner to autonomously navigate in an environment where the AV may need to deviate from a collision buffer restriction. The collision buffer restriction may define, for example and without limitation, a restriction on a distance between the AV and another vehicle(s) in a scene (e.g., a vehicle ahead of the AV, a vehicle behind the AV, a vehicle adjacent to the AV, a school bus, an emergency vehicle, an oversized vehicle that exceeds one or more size restrictions and/or carries cargo exceeding one or more size restrictions, etc.), a restriction on a distance between the AV and a pedestrian in the scene, and/or a restriction on a distance between the AV and an element(s) in the scene (e.g., a crosswalk, a traffic cone, a sidewalk, a parked car, a traffic sign, an intersection, a road hazard, etc.).

As another example, the AV may implement the specialized planner to autonomously perform certain maneuvers where the AV may need to follow a path with a curvature that exceeds a restriction in the navigation planner, implement a certain steering angle and/or steering wheel angle that would deviate from a restriction of the navigation planner, implement a certain behavior that deviates from a restriction and/or parameter of the navigation planner, and/or achieve a pose that deviates from a restriction and/or parameter in the navigation planner. To illustrate, the AV may implement the specialized planner to autonomously park, autonomously perform a maneuver to navigate a cul-de-sac, and/or autonomously perform a merge maneuver, such that the AV may need to achieve a certain pose that would be prohibited and/or unsupported by the navigation planner, the AV may need to implement a certain steering angle (and/or steering wheel angle) and/or follow a path with a curvature that exceeds a restriction (e.g., a steering angle and/or steering wheel angle restriction, a turning restriction, and/or a curvature restriction) of the navigation planner, and/or perform a set of behaviors to complete a maneuver, such as a set of forward, reverse, and/or turn maneuvers used to park in certain cases.

The systems and techniques described herein can be used to autonomously switch between planners used by the AV, such as between the navigation planner and the specialized planner in the previous example. In some cases, the systems and techniques described herein can autonomously switch from the navigation planner to the specialized planner based on one or more factors associated with the specialized planner and/or a use of the specialized planner. For example, the systems and techniques described herein can detect that the AV needs to navigate a certain scene that corresponds to the specialized planner, such as a scene without lanes and/or lane boundaries, and/or detect that the AV needs to perform one or more maneuvers/operations that correspond to the specialized planner, such as a parking maneuver, a merge maneuver, or a maneuver to navigate a cul-de-sac. The systems and techniques described herein can switch from the navigation planner to the specialized planner in response to detecting the certain scene and/or the one or more maneuvers.

In some examples, after detecting the certain scene and/or the one or more maneuvers, the systems and techniques described herein can time and/or trigger the switch based on one or more cues and/or parameters. For example, the systems and techniques described herein can time and/or trigger the switch to the specialized planner when the AV reaches (or is predicted to reach), achieves (or is predicted to achieve), and/or detects (or a certain amount of time after detecting) one or more conditions such as a start of a maneuver and/or operation that deviates from one or more dependencies, rules, and/or restrictions. Non-limiting examples of one or more dependencies, rules, and/or restrictions can include a lane and/or lane boundaries dependency (e.g., a need for or reliance on lanes and/or lane boundaries), a map data dependency (e.g., a need for or reliance on map data such as data from a semantic map, a scene map, and/or a navigation map), a collision buffer restriction (and/or a collision buffer range restriction), a speed restriction and/or speed range restriction, a steering and/or steering wheel angle restriction and/or a restriction on a curvature of a path of travel/motion, a behavior restriction (e.g., stopping at a certain location, performing a certain sequence of maneuvers, etc.), and a pose restriction (e.g., a restriction of a pose of the AV relative to other scene elements such as other vehicles, a traffic marking(s), a traffic sign(s), a semantic element(s), etc.).

To illustrate, the systems and techniques described herein can detect a need to switch to the specialized planner to perform a parking operation. The systems and techniques described herein can determine a number of maneuvers needed to complete (or in which the AV can complete) the parking operation. The systems and techniques described herein can estimate the point in time and/or space to start the first maneuver of the number of maneuvers needed to complete the parking operation, and trigger the switch to the specialized planner at that point in time and/or space. The AV can then use the specialized planner to perform the number of maneuvers and complete the parking operation.

For example, the systems and techniques described herein can determine that the AV can complete the parking operation in a single and/or continuous maneuver. The systems and techniques described herein can then determine the point in time, the location of the AV (e.g., location coordinates of the AV, a location of the AV within a map, a location of the AV relative to a destination or final location, a location of the AV relative to one or more other scene elements, etc.), the pose of the AV (e.g., the pose in space, a space within a map, a pose relative to a final or destination pose, a pose relative to other scene elements, etc.), and/or the distance of the AV to one or more elements (e.g., to a destination or final location and/or pose, to a particular parameter (e.g., an acceleration/deceleration, a steering angle, a pose, etc.), to an object, etc.) at which the AV is predicted to (and/or should) begin the continuous maneuver to complete the parking operation. The systems and techniques described herein can switch to the specialized planner at (or within a threshold of) the determined point in time, location, pose, and/or distance, and use the specialized planner to perform the parking operation.

In some cases, after detecting the scene and/or one or more maneuvers corresponding to the specialized planner, the systems and techniques described herein can time and/or trigger the switch to the specialized planner when the AV reaches a particular state and/or plans to initiate a state that involves a behavior and/or operation that deviates from one or more parameters configured for the navigation planner. For example, the systems and techniques described herein can time and/or trigger the switch to the specialized planner when the AV initiates a move(s), or a threshold amount of time and/or distance of travel before the AV initiates a move(s), that may involve deviating from a restriction of the navigation planner such as, without limitation, a collision buffer restriction, a steering or steering wheel angle restriction, a speed restriction, a behavior restriction, a traffic restriction, a pose restriction, etc.

The systems and techniques described herein can implement the specialized planner to navigate the AV in/along a scene associated with the specialized planner and/or to perform one or more maneuvers/operations associated with the specialized planner, as previously described. The AV can use sensor data to detect scene elements, understand a scene, track a state of the AV and/or one or more objects, and/or obtain measurements in the scene, which the specialized planner can use to trigger and/or control the AV to navigate and/or perform the one or more maneuvers/operations. In some examples, the systems and techniques described herein can similarly trigger an autonomous switch from the specialized planner to the navigation planner (or any other planner). For example, the systems and techniques described herein can trigger an autonomous switch from the specialized planner to the navigation planner when the AV navigates (and/or plans to navigate) a scene associated with the navigation planner and/or when the AV initiates (and/or plans to initiate) one or more maneuvers/operations associated with the navigation planner.

Examples of the systems and techniques described herein for processing data are illustrated in FIG. 1 through FIG. 6 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include one or more inertial measurement units (IMUs), camera sensors (e.g., still image camera sensors, video camera sensors, etc.), light sensors (e.g., LIDARs, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, time-of-flight (TOF) sensors, seat occupancy sensors, open/closed door sensors, tire pressure sensors, rain sensors, and so forth. For example, the sensor system 104 can include a camera system, the sensor system 106 can include a LIDAR system, and the sensor system 108 can include a RADAR system. Other examples may include any other number and type of sensors.

The AV 102 can include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

In some examples, the planning stack 118 can include multiple planning stacks and/or multiple planners (e.g., multiple planning stacks, multiple planning algorithms, multiple planning models, multiple planning nodes, multiple planning software and/or services, and/or multiple planning components) that the AV 102 can use to perform different maneuvers (and/or types of maneuvers), implement different parameters (e.g., different rules, different restrictions, different metrics, different standards, different states, and/or different behaviors), and/or navigate different scenes/environments (and/or types of scenes/environments), different conditions, different limitations, etc. For example, in some cases, the planning stack 118 can include a navigation planner and a specialized planner, as previously described. In some examples, the planning stack 118 can additionally or alternatively include other planners and/or a different number of planners. The local computing device 110 can intelligently and autonomously switch between different planners in/of the planning stack 118, as further described herein. For example, the local computing device 110 can autonomously switch between different planners in/of the planning stack 118 based on one or more factors such as, without limitation, a traffic rule, a restriction, a behavior, a scene, a state of the AV 102, a metric, a condition, a limitation, etc.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can include multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs (e.g., AV 102), Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the client application (e.g., ridehailing application 172) to enable passengers to view the AV 102 in transit to a pick-up or drop-off location, and so on.

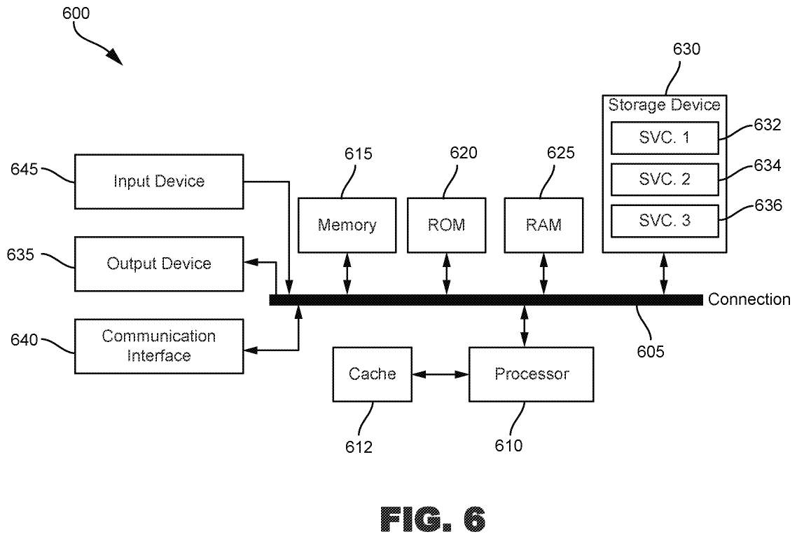

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can, in some instances, include one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

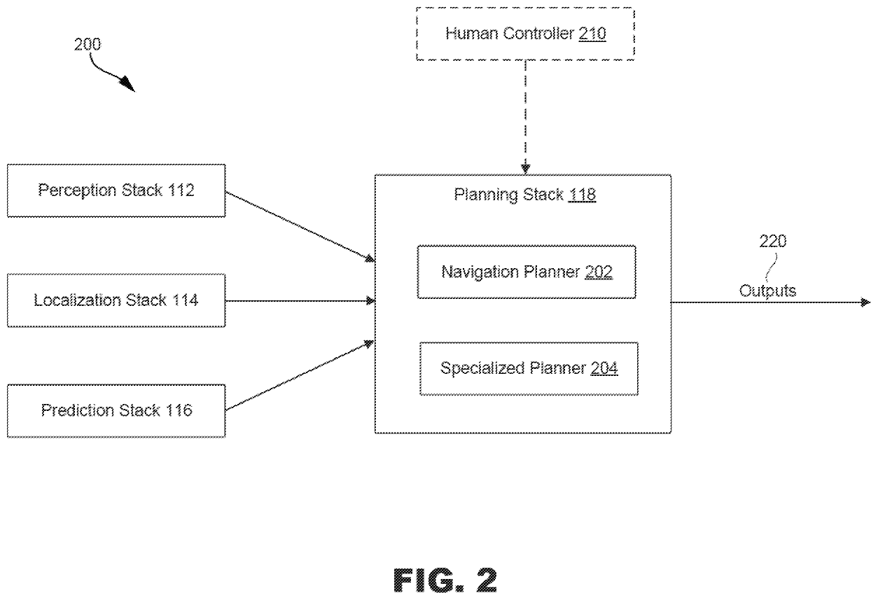

FIG. 2 is a diagram illustrating an example planning system 200 with multiple planners implemented by the AV 102 to perform various planning operations, according to some examples of the present disclosure. In some cases, the planning system 200 can include or be part of the planning stack 118 of the local computing device 110 of the AV 102, as previously described. In this example, the planning stack 118 includes a navigation planner 202 and a specialized planner 204. In other examples, the planning stack 118 can include one or more different types of planners than shown in FIG. 2 and/or a different number of planners than shown in FIG. 2. The navigation planner 202 and the specialized planner 204 are provided in FIG. 2 as illustrative examples for explanation purposes.

In some examples, the navigation planner 202 and the specialized planner 204 can each include one or more algorithms, one or more nodes, one or more machine learning models, one or more software stacks, one or more software services, and/or one or more software components. The navigation planner 202 and the specialized planner 204 can be configured to perform different behaviors/operations and/or implement different rules, restrictions, and/or parameters. Moreover, the planning stack 118 can implement the navigation planner 202 and the specialized planner 204 for different scenes (and/or types of scenes), different maneuvers (and/or types of maneuvers), different conditions, different metrics, different restrictions, different rules, and/or different parameters.

In some examples, the AV 102 can use the navigation planner 202 to navigate in certain scenes and/or perform certain maneuvers/operations. For example, in some cases, the AV 102 can use the navigation planner 202 to navigate scenes that include lanes, that include lane boundaries defined in a map used by the AV 102 such as a semantic and/or navigation map, and/or that include certain restrictions such as a collision buffer restriction(s) (e.g., a restriction specifying an amount of distance that the AV 102 needs to maintain from other vehicles when navigating a scene, such as a vehicle ahead of the AV 102, a vehicle behind the AV 102, and/or a vehicle(s) adjacent to the AV 102). On the other hand, the AV 102 can use the specialized planner 204 in other scenes that are not associated with the navigation planner 202 and/or for other maneuvers/operations that are not associated with the navigation planner 202. For example, assume that the navigation planner 202 includes a planner used for scenes in which the navigation planner 202 relies on certain scene elements to navigate, such as lanes or lane boundaries. In this example, the specialized planner 204 can include a planner used by the AV 102 to navigate other scenes where the specialized planner 204 (and/or the AV 102) may not rely on the scene elements used by the navigation planner 202 to navigate, such as lanes and/or lane boundaries.

In some examples, the specialized planner 204 can additionally or alternatively include a planner used by the AV 102 to perform certain maneuvers/operations that may involve deviating from certain parameters implemented by the navigation planner 202, such as certain rules, restrictions, and/or behaviors, among others. To illustrate, the AV 102 may implement the specialized planner 204 to autonomously navigate in an environment where the AV 102 may need to deviate from a collision buffer restriction(s) associated with the navigation planner 202. For example, the specialized planner 204 may not have a collision buffer restriction or may have one or more collision buffer restrictions that permit certain behavior, parameters/metrics, and/or operations that would deviate from (e.g., violate, etc.) a collision buffer restriction(s) of the navigation planner 202. The collision buffer restriction may define, for example and without limitation, a restriction on a distance between the AV 102 and another vehicle(s) in a scene (e.g., a vehicle ahead of the AV, a vehicle behind the AV, a vehicle adjacent to the AV, a school bus, an emergency vehicle, an oversized vehicle that exceeds one or more size restrictions and/or carries cargo exceeding one or more size restrictions, etc.), a restriction on a distance between the AV and a pedestrian in the scene, and/or a restriction on a distance between the AV and an element(s) in the scene (e.g., a crosswalk, a traffic cone, a sidewalk, a parked car, a traffic sign, an intersection, a road hazard, etc.).

The AV 102 may additionally or alternatively implement the specialized planner 204 to autonomously perform certain maneuvers where the AV 102 may need to implement a certain steering angle and/or steering wheel angle, (e.g., and/or the AV 102 may need to follow a path with a curvature that exceeds a restriction in the navigation planner 202), implement a certain behavior (e.g., parking, a merge behavior, a u-turn, and/or another behavior) that deviates from one or more parameters of the navigation planner 202, and/or achieve a pose (e.g., a pose in space, a pose relative to a reference point in space and/or a map, a pose relative to one or more objects and/or scene elements, a pose relative to one or more coordinates, a pose relative to one or more reference points and/or aspects of a map, etc.) that deviates from one or more restrictions in the navigation planner 204. To illustrate, the AV 102 may implement the specialized planner 204 to autonomously park, autonomously perform a maneuver to navigate a cul-de-sac, and/or autonomously perform a merge maneuver, such that the AV 102 may need to maintain and/or achieve a certain pose that would be prohibited and/or unsupported by the navigation planner 202, the AV 102 may need to implement a steering angle (and/or steering wheel angle) and/or follow a path with a curvature that exceed(s) one or more restrictions (e.g., a steering angle and/or steering wheel angle restriction, a turning restriction, a curvature restriction, etc.) of the navigation planner 202, and/or perform a set of maneuvers/behaviors that may conflict with a restriction associated with the navigation planner 202, such as a sequence of forward, reverse, and/or turn maneuvers used to park in certain spaces.

The AV 102 (e.g., the local computing device 110, the planning stack 118, and/or a separate component such as a controller, an algorithm, a model, and/or the control stack 122) can autonomously switch between the navigation planner 202 and the specialized planner 204 based on one or more factors and/or as needed. In some cases, the AV 102 can autonomously switch from the navigation planner 202 to the specialized planner 204 based on one or more factors associated with the specialized planner 204 and/or a use of the specialized planner 204, based on one or more factors and/or restrictions of the navigation planner 202, and/or based on one or more rules associated with the specialized planner 204. For example, the local computing device 110 of the AV 102 can detect that the AV 102 needs to navigate a certain scene that corresponds to the specialized planner 204, such as a scene without lanes and/or lane boundaries, and/or detect that the AV 102 needs to perform one or more maneuvers/operations that correspond to the specialized planner 204, such as a parking maneuver, a merge maneuver, or a maneuver to navigate a cul-de-sac. The local computing device 110 of the AV 102 can switch from the navigation planner 202 to the specialized planner 204 in response to detecting the certain scene and/or the one or more maneuvers, and use the specialized planner 204 to navigate the scene and/or perform the one or more maneuvers.

In some examples, after detecting the certain scene and/or the one or more maneuvers, the local computing device 110 of the AV 102 (e.g., and/or the control stack 122, the planning stack 118, an algorithm, a model, a controller, and/or another component of the AV 102) can time and/or trigger the switch between planners based on one or more cues and/or parameters. For example, the local computing device 110 of the AV 102 can time and/or trigger the switch from the navigation planner 202 to the specialized planner 204 when the AV 102 reaches (or is predicted to reach), achieves (or is predicted to achieve), and/or detects (or a certain amount of time after detecting) one or more conditions such as a start of a maneuver and/or operation that deviates from one or more dependencies, rules, and/or restrictions of the navigation planner 202. Non-limiting examples of one or more dependencies, rules, and/or restrictions of the navigation planner 202 can include a lane and/or lane boundaries dependency (e.g., a need for or reliance on lanes and/or lane boundaries), a map data dependency (e.g., a need for or reliance on map data such as data from a semantic map, a scene map, and/or a navigation map), a collision buffer restriction (and/or a collision buffer range restriction), a speed restriction and/or speed range restriction, a steering and/or steering wheel angle restriction, a restriction on a curvature of a path of travel/motion, a behavior restriction (e.g., stopping at a certain location, performing a certain sequence of maneuvers, etc.), and a pose restriction (e.g., a restriction of a pose of the AV 102 in space and/or relative to other scene elements such as other vehicles, a traffic marking(s), a traffic sign(s), a semantic element(s), etc.).

To illustrate, the local computing device 110 of the AV 102 can detect a need to switch to the specialized planner 204 to perform a parking operation. The local computing device 110 of the AV 102 can determine a number of maneuvers (e.g., one or more maneuvers) needed to complete (or in which the AV can complete) the parking operation, and estimate a point in time and/or space to start the first maneuver of the number of maneuvers needed to complete the parking operation. The local computing device 110 of the AV 102 can then trigger the switch to the specialized planner 204 at that point in time and/or space. The AV 102 can use the specialized planner 204 to perform the number of maneuvers and complete the parking operation.

As another example, the local computing device 110 of the AV 102 can determine that the AV 102 can complete the parking operation in a single and/or continuous maneuver. The local computing device 110 of the AV 102 can determine the point in time, the location of the AV 102 (e.g., location coordinates of the AV 102, a location of the AV 102 within a map, a location of the AV 102 relative to a destination or final location, a location of the AV 102 relative to one or more other scene elements, etc.), the pose of the AV 102 (e.g., the pose in space, a pose in a space within a map, a pose relative to a final or destination pose, a pose relative to other scene elements, etc.), and/or the distance of the AV 102 to one or more elements (e.g., to a destination or final location and/or pose, to a particular parameter (e.g., an acceleration/deceleration, a steering angle, a pose, etc.), to an object, etc.) at which the AV 102 is predicted to (and/or should) begin the single and/or continuous maneuver to complete the parking operation. The local computing device 110 of the AV 102 can switch to the specialized planner 204 at (or within a threshold of) the determined point in time, location, pose, and/or distance, and use the specialized planner 204 to perform the parking operation.

In some cases, after detecting the scene and/or one or more maneuvers corresponding to the specialized planner 204, the local computing device 110 of the AV 102 can time and/or trigger the switch to the specialized planner 204 when the AV reaches a particular state (and/or is predicted to reach the particular state) and/or plans to initiate a state that involves a behavior and/or operation that deviates from one or more restrictions and/or parameters of the navigation planner 202. For example, the local computing device 110 of the AV 102 can time and/or trigger the switch to the specialized planner 204 when the AV 102 initiates a move(s) (e.g., or a threshold amount of time and/or distance of travel before the AV initiates a move), that may involve deviating from a restriction and/or parameters of the navigation planner 202 such as, without limitation, a collision buffer restriction(s), a steering or steering wheel angle restriction(s), a speed restriction(s), a behavior restriction(s), a traffic restriction(s), a pose restriction(s), an operation parameter(s), etc.

The AV 102 can implement the specialized planner 204 to navigate the AV 102 in/along a scene associated with the specialized planner 204 and/or to perform one or more maneuvers/operations associated with the specialized planner 204, as previously described. The AV 102 can use sensor data to detect scene elements, understand a scene, track a state of the AV 102 and/or one or more objects, and/or obtain measurements in the scene, which the specialized planner 204 can use to trigger and/or control the AV 102 to navigate and/or perform the one or more maneuvers/operations.

As shown in FIG. 2, in some cases, the planning stack 118 can receive data from the perception stack 112, the localization stack 114, and/or the prediction stack 116, which the planning stack 118 (e.g., the navigation planner 202, the specialized planner 204) can use to generate one or more outputs 220. For example, the navigation planner 202 and the specialized planner 204 can use data from the perception stack 112, the localization stack 114, and/or the prediction stack 116, and generate one or more respective outputs. The data from the perception stack 112, the localization stack 114, and/or the prediction stack 116 can include, for example and without limitation, a pose and/or location of the AV 102 (and/or a predicted pose and/or location of the AV 102), a pose and/or location of one or more other scene elements (e.g., other vehicles, pedestrians, traffic signs, buildings, crosswalks, intersections, road objects, etc.), a trajectory and/or route of the AV 102, a trajectory and/or state of other road elements (e.g., vehicles, pedestrians, bicycles, etc.), elements (e.g., objects, vehicles, pedestrians, semantic elements (e.g., crosswalks, intersections, parking spots, spaces, traffic signs, etc.) detected in a scene associated with the AV 102, visual markings and/or cues detected in the scene, data describing one or more aspects of the scene, a predicted status of the AV 102 and/or one or more elements in the scene of the AV 102, a predicted state (e.g., a predicted trajectory, operation, behavior, destination, change in state and/or status, etc.) of the AV 102 and/or one or more elements in the scene, and a predicted metric of the AV 102 and/or one or more elements in the scene, among others.

In some cases, the planning stack 118 can additionally or alternatively receive data from a human controller 210, and the planning stack 118 (e.g., the navigation planner 202, the specialized planner 204) can use the data from the human controller 210 (alone or in addition to other data such as data from the perception stack 112, localization stack 114, and/or prediction stack 116) to generate the one or more outputs 220. For example, the specialized planner 204 can use data from the human controller 210 (e.g., alone or in addition to other data such as data from the perception stack 112, the localization stack 114, and/or the prediction stack 116) to generate one or more planning outputs as further described herein. In some examples, the data from the human controller 210 can include one or more parameters, one or more restriction overrides (e.g., data and/or instructions overriding one or more restrictions configured in the software of the planning stack 118, the navigation planner 202, and/or the specialized planner 204), a request to activate the specialized planner 204 (and/or switch from the navigation planner 202 to the specialized planner 204, or vice versa), instructions/commands, and/or other data. For example, in some cases, the data from the human controller 210 can include instructions to switch to (and/or instructions to activate) a different planner (e.g., from the navigation planner 202 to the specialized planner 204 or vice versa), instructions specifying when the planning stack 118 should switch to the different planner (e.g., one or more triggers and/or parameters that specify when the planning stack 118 should switch to the different planner), one or more commands to control one or more operations of the AV 102 (e.g., to control the AV 102 until the different planner is activated, to assist the current planner until or before the different planner is activated, and/or to assist the different planner when and/or after the different planner is activated).

In another example, the data from the human controller 210 can provide one or more parameters to the different planner for use by the different planner in performing one or more maneuvers and/or navigating the AV 102. For example, the human controller 210 can provide the specialized planner 204 an instruction to override or waive one or more restrictions (e.g., a vehicle and/or obstacle buffer restriction, a speed restriction, a maneuver restriction, a turning or steering wheel angle restriction, a steering wheel angle restriction, a pose restriction, and/or any other restriction defined in software) configured in the planning stack 118, the navigation planner 202, and/or the specialized planner 204; data specifying a desired pose of the AV 102 during any point of a maneuver and/or at a completion of a maneuver; data specifying one or more rules for performing a maneuver; data specifying one or more settings (e.g., a speed setting, a turning or steering angle setting, a steering wheel angle setting, an obstacle buffer setting, a pose setting, a permission setting, a restriction setting, a safety setting, a performance setting, a behavior setting, and/or any other setting) the AV 102 should use to implement a maneuver and/or navigate the AV 102; and/or any other data.

In some examples, the data from the human controller 210 can additionally or alternatively include, for example and without limitation, a pose and/or location of the AV 102 (and/or a predicted pose and/or location of the AV 102), a pose and/or location of one or more other scene elements (e.g., other vehicles, pedestrians, traffic signs, buildings, crosswalks, intersections, road objects, etc.), a trajectory and/or route of the AV 102, a trajectory and/or state of other road elements (e.g., vehicles, pedestrians, bicycles, etc.), elements (e.g., objects, vehicles, pedestrians, semantic elements (e.g., crosswalks, intersections, parking spots, spaces, traffic signs, etc.) detected in a scene associated with the AV 102, visual markings and/or cues detected in the scene, data describing one or more aspects of the scene, a predicted status of the AV 102 and/or one or more elements in the scene of the AV 102, a predicted state (e.g., a predicted trajectory, operation, behavior, destination, change in state and/or status, etc.) of the AV 102 and/or one or more elements in the scene, and a predicted metric of the AV 102 and/or one or more elements in the scene, among others.

In some examples, the human controller 210 can include an operator physically located in the AV 102 or a scene of the AV 102, or a remote operator that can control and/or communicate with the AV 102 (e.g., with the local computing device 110 of the AV 102) wirelessly and/or via one or more networks using a computing device, such as a laptop computer, a desktop computer, a tablet computer, a smartphone, a server computer, a virtual device (e.g., a head-mounted display, smart glasses, etc.), a smart television, and/or any other computing device. For example, if the operator is physically located in the AV 102, the operator can manually control the AV 102 and/or provide inputs directly to (and/or in) the AV 102. If the operator is located remotely, the operator may use a computer device to communicate with the AV 102 (e.g., with the local computing device 110) remotely via one or more networks (e.g., via a local area network, a wide area network, a cloud network, a public network, a private network, a hybrid public and private network or cloud, the Internet, a virtual private network, and/or any other network(s)). In some cases, if the operator is outside of the AV 102 but within a scene of the AV 102 and/or within a certain proximity of the AV 102 (e.g., within a wireless range for a point-to-point or ad hoc connection with the AV 102), the human controller 210 can use a computing device to establish a direct, peer-to-peer, and/or ad hoc connection to the AV 102 (e.g., to the local computing device 110), which the human controller 210 can use to communicate with the AV 102 and/or provide data to the AV 102. To illustrate, if the human controller 210 is outside of the AV 102 but within a wireless range, the human control 210 can use a computing device to wirelessly (e.g., via BLUETOOTH® wireless, BLUETOOTH® low energy (BLE) wireless, IBEACON® wireless, a radio-frequency wireless, near-field communications, dedicated short range communication (DSRC), 802.11 Wi-Fi, infrared, and/or any other wireless technology) communicate with the AV 102 and provide and/or receive any data to/from the AV 102.

As previously noted, the navigation planner 202 and the specialized planner 204 can generate one or more outputs based on the data from the perception stack 112, the localization stack 114, the prediction stack 116, the human controller 210, and/or one or more sensors. For example, the specialized planner 204 can generate the outputs 220 based on data from the perception stack 112, the localization stack 114, the prediction stack 116, and/or the human controller 210, with or without data collected in the scene from one or more sensors (e.g., sensor system 104, sensor system 106, and/or sensor system 108). The outputs 220 can include planning outputs. For example, the outputs 220 can include one or more navigation and/or maneuver instructions/commands, settings, and/or parameters; one or more restrictions; one or more permissions (e.g., one or more permissions to perform a maneuver and/or achieve one or more parameters and/or metrics, etc.); one or more rules (e.g., traffic rules, operation rules, etc.); one or more routes; one or more operations to perform; one or more instructions; one or more conditions; one or more restriction waivers and/or overrides (e.g., a waiver and/or override of a vehicle or obstacle buffer restriction, a waiver and/or override of a speed restriction, a waiver and/or override of a pose restriction, etc.), one or more navigation plans; and/or any other planning data.

In some examples, the local computing device 110 of the AV 102 can similarly trigger an autonomous switch from the specialized planner 204 to the navigation planner 202. For example, the local computing device 110 of the AV 102 can trigger an autonomous switch from the specialized planner 204 to the navigation planner 202 when the AV 102 navigates (and/or plans to navigate) a scene associated with the navigation planner 202 (e.g., a scene with lanes and/or lane boundaries, a scene with one or more restrictions associated with the navigation planner 202, etc.) and/or when the AV 102 initiates (and/or plans to initiate) one or more maneuvers/operations associated with the navigation planner 202. In some cases, the local computing device 110 of the AV 102 can trigger the switch to the navigation planner 202 autonomously before navigating such scene and/or performing such maneuver based on one or more cues and/or factors. For example, the local computing device 110 of the AV 102 can trigger the switch to the navigation planner 202 in response to detecting (and/or predicting) a location and/or pose of the AV 102 (e.g., in space and/or relative to one or more items such as a vehicle, a semantic element, a reference point in space and/or a map, a location and/or pose of the AV 102 selected to begin a maneuver(s) and/or begin navigation using the navigation planner 202, etc.), detecting a change in a context of the AV 102 (e.g., a change in scene, a change in traffic rules, a change in restrictions, a change in restriction waivers, a change in a type of scene and/or environment, a change of one or more conditions, a change in one or more parameters, etc.), detecting a change in a status of the AV 102 and/or one or more other items, etc.

In some cases, the local computing device 110 of the AV 102 can trigger a switch from a planner to another planner, such as from the navigation planner 202 to the specialized planner 204 and/or vice versa, based on an input from the human controller 210. For example, the local computing device 110 can receive a command instructing the local computing device 110 to switch (and/or when to switch) from the navigation planner 202 to the specialized planner 204 or a command instructing the local computing device 110 to switch (and/or when to switch) from the specialized planner 204 to the navigation planner 202.

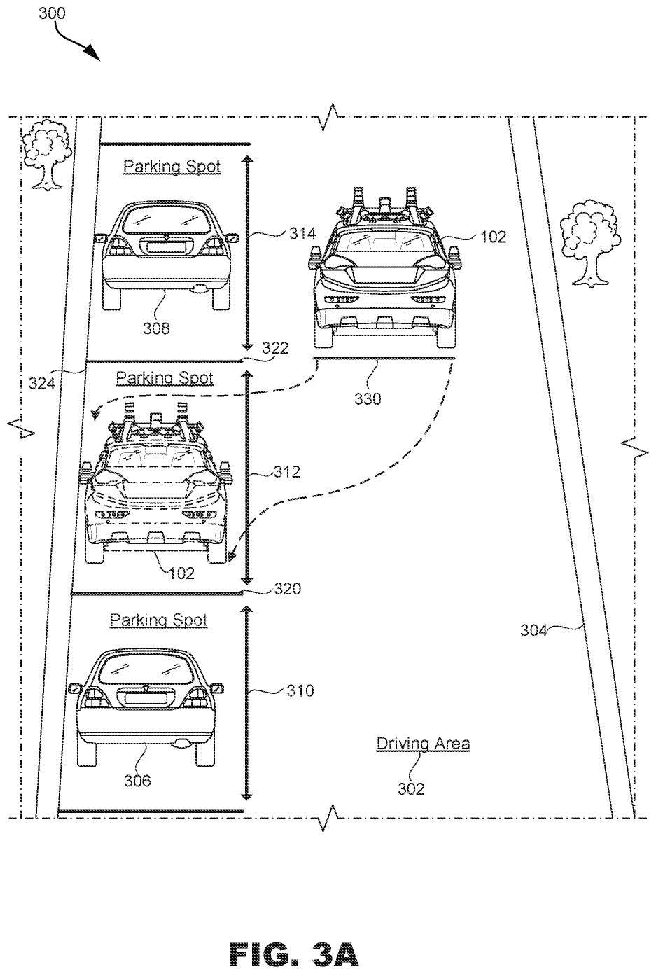

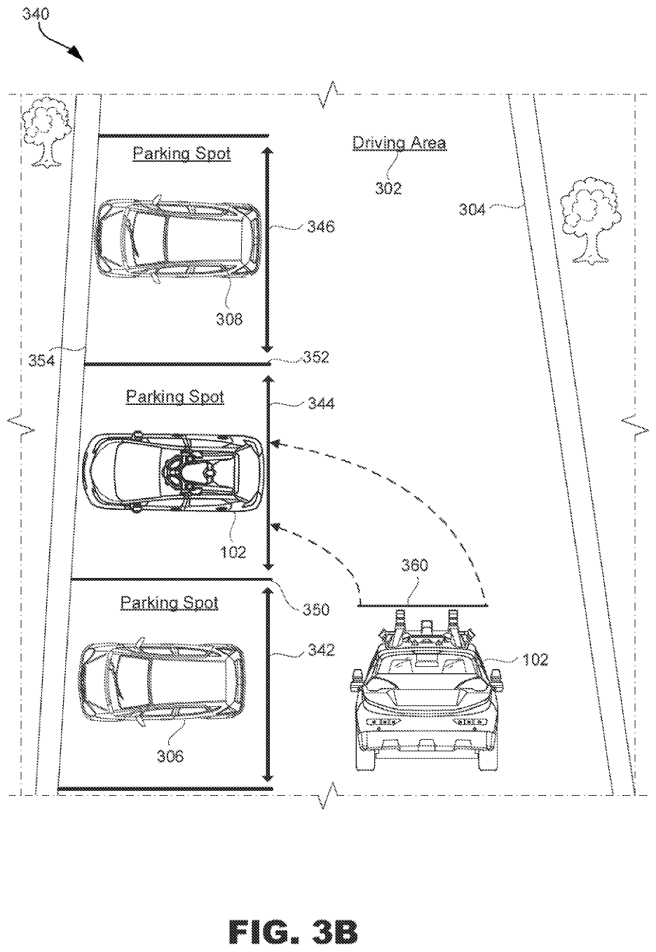

FIG. 3A is a diagram illustrating an example use case for implementing a specialized planner (e.g., specialized planner 204) of the AV 102 to perform a maneuver in an example scene 300. In this example, the use case includes performing a parallel parking maneuver using the specialized planner, and the scene 300 includes a parking scene such as, for example and without limitation, a parking garage with parallel parking spaces, a parking lot with parallel parking spaces, a road/street with parallel parking spaces, or any other scene with parallel parking spaces.

As shown, the scene 300 in FIG. 3A includes parking spaces 310-314 where vehicles can park by parallel parking into the parking spaces 310-314 or by otherwise driving into the parking spaces 310-314. The parking spaces 310-314 are parallel/adjacent to a boundary 324 shared by the parking spaces 310-314, a boundary 304 of a driving area 302 in the scene 300, and vehicles traveling along the driving area 302 in the scene 300. The parking spaces 310-314 are also designed for vehicles to park in the parking spaces 310-314 at an angle that is perpendicular to (or within a threshold angle from) an angle of two boundaries of the boundaries of the parking spaces, such as boundaries 320-322 of the parking space 312. For example, the parking space 312 is designed for a vehicle to park in the parking space 312 with a rear and front of the vehicle facing (or facing towards) the boundaries 320-322 of the parking space 312.

The AV 102 can implement the specialized planner to park in an available parking space, such as parking space 312 illustrated in FIG. 3A. In some examples, the AV 102 can additionally use the specialized planner to navigate the scene 300. In other cases, the AV 102 may use a navigation planner (e.g., navigation planner 202) to navigate the scene 300 and switch to the specialized planner to park, as further described herein.

The scene 300 also includes the driving area 302 where vehicles (e.g., including the AV 102) looking to park in any of the parking spaces 310-314 can drive/navigate to look for and/or approach available parking spaces, and previously-parked vehicles (e.g., vehicles previously parked in any of the parking spaces 310-314) can navigate when leaving (to leave) the scene 300 upon leaving a parking space. The driving area 302 in this example is between the parking spaces 310-314 and a boundary 304, which in this example represents a curb, wall, or fence. The vehicles navigating through the driving area 302 can travel along a direction that is parallel/adjacent to a position of vehicles parked in the parking spaces 310-314. It should be noted that the scene 300, the parking spaces 310-314, the driving area 302, and the boundary 304 are merely examples provided for explanation purposes. Other example scenes may include a different configuration, such as a different type(s) and/or number of parking spaces, a different driving area types and/or configurations, different number of driving areas, different boundaries, etc. Another example scene is illustrated in FIG. 3B and further described below with respect to FIG. 3B.

In some cases, the AV 102 can drive forward into an available parking space to parking in that parking space. For example, if the available parking space is in front (e.g., relative to a direction of travel of the AV 102) of another available parking space, the AV 102 may have sufficient room to simply drive forward and turn into the available parking space using the specialized planner. Similarly, if the available parking space is in front (e.g., relative to a direction of travel of the AV 102) of an area that is not occupied by other vehicles or objects and is sufficiently large to allow the AV 102 to simply drive forward and turn into the available parking space, the AV 102 may simply drive forward and turn into the available parking space using the specialized planner as the AV 102 has enough room to drive into the available parking space. In the example shown in FIG. 3B, the parking space 310 behind (e.g., relative to a direction of travel of the AV 102 through the driving area 302) the parking space 312 available for the AV 102 and the parking space 314 in front (e.g., relative to the direction of travel of the AV 102) of the parking space 312 are both occupied by vehicle 306 and vehicle 308, respectively. Accordingly, in this example, the AV 102 may decide to parallel park into the parking space 312 using the specialized planner, as it may be easier in this instance to parallel park into the parking space 312 than to drive into the parking space 312.

The AV 102 can detect that the parking space 312 is available based on sensor data collected by one or more sensors (e.g., sensor system 104, sensor system 106, sensor system 108) of the AV 102. For example, the AV 102 can use sensor data (e.g., data from a camera sensor, data from a LIDAR, data from a RADAR, etc.) to detect the boundaries 320 and 322 of the parking space 312 and determine that there are no vehicles, motorcycles, bicycles, or objects (e.g., any objects, objects of a threshold size, objects located within the boundaries 320 and 322, and/or objects located within the parking space 312 at more than a threshold distance away from the boundaries 320 and 322) within the boundaries 320 and 322. In some cases, the AV 102 can additionally detect boundary 324 of the parking space 312, and use the boundary 324 to determine that there are no vehicles, motorcycles, bicycles, or objects within the boundaries 320, 322, and 324.

In some cases, a boundary of the parking space 312 (e.g., the boundary 320, the boundary 322, and/or the boundary 324) can include or be defined/represented by a visual marking, such as a line defining the boundary. In other cases, a boundary of the parking space 312 (e.g., the boundary 320, the boundary 322, and/or the boundary 324) can include or be defined/represented by one or more objects and/or cues such as, for example and without limitation, one or more cones, a curb, a wall, a barrier or barricade, a traffic object(s), a sign(s), a vehicle (e.g., a transportation vehicle, a reference vehicle, etc.) used to define a boundary/border, a fence, a separation (and/or indication of a separation) of an area of the parking space 312 with another area outside of the parking space 312 (e.g., a separation from a concrete area of the parking space 312 to another type of area (or vice versa) that is outside of the parking space 312, such as a grassy area, a dirt area, a pebble stone or cobblestone area, a sand area, etc.), a visual marker (e.g., a line, etc.), and/or any other objects and/or cues.

If there are no vehicles, motorcycles, bicycles, or objects within the boundaries 320, 322, and 324 of the parking space 312, the AV 102 can determine that the parking space 312 is unoccupied and available for the AV 102 to park in. In this example of FIG. 3A, after determining that there are no vehicles, motorcycles, bicycles, or objects within the boundaries 320, 322, and 324 of the parking space 312, the AV 102 can switch to the specialized planner and use the specialized planner to parallel park into the parking space 312. The specialized planner can use the boundaries 320, 322, and 324 as guides used to park the AV 102 within the parking space 312.

The specialized planner can include a planner configured to provide plans or planning data to the AV 102 for performing one or more parking maneuvers, such as parallel parking. In some examples, the specialized planner can also be configured to (and/or can be allowed/enabled to) deviate from one or more restrictions of a navigation planner used by the AV 102 in other use cases, such as navigating other scenes, and that the AV 102 may need to deviate from in order to park in the parking space 312. For example, the specialized planner can be configured to allow the AV 102 to exceed a collision buffer restriction of the navigation planner in order to get closer to other vehicles, such as other parked vehicles (e.g., vehicle 306 and vehicle 308), as needed and/or desired in order to park in spaces between other spaces occupied by other vehicles, bicycles, motorcycles, and/or objects. To illustrate, when parked in the parking space 312 (and/or to park in the parking space 312), the AV 102 may need to be/get closer to the vehicle 306 and/or the vehicle 308 than would otherwise be allowed by a collision buffer restriction of a navigation planner if the AV 102 where using the navigation planner.

As another example, the specialized planner can additionally or alternatively be configured to allow the AV 102 to deviate from (e.g., exceed) a steering angle restriction (e.g., a restriction on a steering angle at all or for a duration of time and/or an amount of distance traveled), deviate from (e.g., exceed) a steering wheel angle restriction (e.g., a restriction on a steering wheel angle at all or for a duration of time and/or an amount of distance traveled), and/or follow a path with an angle/curvature that deviates from (e.g., exceeds) an angle/curvature restriction (e.g., a restriction on an angle/curvature achieved or followed at all or for an amount of time and/or distance traveled) of a navigation planner used by the AV 102 in other use cases, such as navigating other scenes, and that the AV 102 may need to deviate from in order to park in the parking space 312. In this example, the AV 102 may need to exceed the steering angle restriction, the steering wheel angle restriction, and/or the angle/curvature restriction associated with the navigation planner in order to perform the parallel parking maneuver to move the AV 102 from a location in the driving area 302 to a location within the parking space 312.

As yet another example, the specialized planner (e.g., specialized planner 204) can additionally or alternatively be configured to allow the AV 102 to achieve a certain pose that would otherwise be prohibited by one or more restrictions of a navigation planner (e.g., navigation planner 202) used by the AV 102 in other uses cases, such as navigating other scenes, and that the AV 102 may need to achieve to park in the parking space 312. For example, the navigation planner may have a restriction on the position of the AV 102 relative to a boundary (e.g., the relative location of the AV 102 and/or the distance of the AV 102 relative to the boundary, the angle or orientation of the AV 102 relative to the boundary, etc.) such as a curb or grassy area that defines a boundary of the parking space 312, the position of the AV 102 relative to other moving vehicles in the scene (e.g., the relative location of the AV 102 and/or the distance of the AV 102 relative to the moving vehicles, the angle or orientation of the AV 102 relative to the vehicles, etc.) such as other vehicles driving in the driving area 302, the position of the AV 102 relative to one or more semantic elements in the scene (e.g., the relative location of the AV 102 and/or the distance of the AV 102 relative to the one or more semantic elements, the angle or orientation of the AV 102 relative to the one or more semantic elements, etc.) such as a semantic object (e.g., a crosswalk, a sidewalk, a lane, a curb, a barrier, a median, etc.), and/or a position of the AV 102 relative to one or more reference points (e.g., the relative location of the AV 102 and/or the distance of the AV 102 relative to the one or more reference points, the angle or orientation of the AV 102 relative to the one or more reference points, etc.). The AV 102 may need to achieve and/or maintain a pose(s) prohibited by the one or more restrictions associated with the navigation planner, in order to park in the parking space 312 and/or remain in the parking space 312 for a period of time.

In some examples, the AV 102 may use the specialized planner to navigate the driving area 302 of the scene 300 and park in the parking space 312. For example, if the driving area 302 of the scene 300 does not include lanes and/or lane boundaries, the AV 102 may use the specialized planner to both navigate the driving area 302 and park in the parking space 312. The local computing device 110 of the AV 102 may autonomously switch from a navigation planner used to navigate another scene with one or more restrictions that are not applicable to the scene 300, to the specialized planner. In some cases, the local computing device 110 of the AV 102 can trigger or time the switch to the specialized planner when (and/or for/at a time when) the AV 102 transitions (or is predicted to transition within a threshold amount of time and/or a threshold traveling distance) from the scene associated with the navigation planner to the scene 300 associated with the specialized planner.

In other examples, the AV 102 may use the navigation planner noted above to navigate the driving area 302 of the scene 300, and may use the specialized planner to park in the parking space 312 (e.g., to perform a parallel parking maneuver to park in the parking space 312). To park in the parking space 312, the local computing device 110 of the AV 102 may autonomously switch from the navigation planner (or another planner) to the specialized planner. The local computing device 110 of the AV 102 can autonomously switch to the specialized planner based on one or more factors and/or cues. For example, the local computing device 110 of the AV 102 may identify a point in time and/or space to switch to the specialized planner. To illustrate, in the example of FIG. 3A, the local computing device 110 of the AV 102 may identify the switching point 330 and trigger a switch to the specialized planner when the AV 102 reaches the switching point 330.

In some examples, the switching point 330 can refer to a location and/or orientation of the AV 102 at a certain time when approaching the parking space 312, and/or a location, distance, and/or orientation of the AV 102 relative to one or more reference points such as, for example and without limitation, the boundary 320 (e.g., the location and/or orientation of the boundary 320), the boundary 322 (e.g., the location and/or orientation of the boundary 322) of the parking space 312, the boundary 324 (e.g., the location and/or orientation of the boundary 324), the vehicle 306 in the parking space 310 and/or the vehicle 308 in the parking space 314, a predicted (and/or desired) pose of the AV 102 when the AV 102 completes parking in the parking space 312, and/or relative to any other reference points. In some cases, the switching point 330 can include a location and/or orientation that the AV 102 may need to reach to complete the parking maneuver and achieve a certain pose/location within the parking space 312 in a certain number of maneuvers such as, for example, a certain number of turning, stopping, acceleration, and/or deceleration maneuvers and/or a certain number of changes in a direction of travel and/or steering angle (or steering wheel angle) of the AV 102, an acceleration of the AV 102, a deceleration of the AV 102, a pose of the AV 102, a speed of the AV 102, and/or any other state/status of the AV 102.

For example, if the local computing device 110 of the AV 102 chooses to perform the parallel parking maneuver to park the AV 102 in the parking space 312 as a single maneuver (e.g., a parallel parking maneuver performed without stopping the AV 102 from a beginning to an end of the parallel parking maneuver), the switching point 330 can include a position (e.g., location and/or orientation) of the AV 102 that the local computing device 110 of the AV 102 estimates the AV 102 needs to have at a start of the parallel parking in order to complete the parallel parking as a single or within a single maneuver.

As another example, if the local computing device 110 of the AV 102 chooses to perform the parallel parking as a sequence (or continuous sequence) of maneuvers (e.g., as a sequence of changes in acceleration, deceleration, direction and/or angle of travel/turning (e.g., a steering or steering wheel angle, a curvature of a path, etc.) with or without stopping the AV 102 from a beginning to an end of the sequence (or continuous sequence) of maneuvers), the switching point 330 can include a position (e.g., location and/or orientation) of the AV 102 that the local computing device 110 of the AV 102 estimates the AV 102 needs to have at a start of the parallel parking in order to complete the parallel parking as or within the sequence (or continuous sequence) of maneuvers.

As yet another example, if the local computing device 110 of the AV 102 chooses to complete the parallel parking within a specific amount of time, the switching point 330 can include a position (e.g., location and/or orientation) of the AV 102 that the local computing device 110 of the AV 102 estimates the AV 102 needs to have when starting the parallel parking maneuver in order to complete the parallel parking within the specific amount of time.

In some cases, the switching point 330 can additionally or alternatively include a position (e.g., location and/or orientation) of the AV 102 that the local computing device 110 of the AV 102 estimates that the AV 102 needs to have in order to perform the parallel parking maneuver without exceeding a particular metric(s) and/or constraint(s) such as, for example and without limitation, a performance metric, a safety metric, a distance metric, a pose metric, a collision buffer constraint (e.g., a minimum amount of distance between the AV 102 and the vehicle 306, the vehicle 308, and/or other vehicles in the scene 300), a steering angle (or range of steering angles) and/or steering wheel angle (and/or range of steering wheel angles), a minimum speed, a maximum speed, a maximum turning angle, a minimum distance, a maximum distance, and/or any other metrics and/or constraints. For example, the switching point 330 can include a position that the AV 102 needs to have to perform and complete the parallel parking maneuver while maintaining at least a threshold distance to other vehicles (e.g., vehicle 306, vehicle 308, other vehicles, etc.) during the parallel parking maneuver and/or at the end of the parallel parking maneuver. As another example, the switching point 330 can include a position that the AV 102 needs to have to achieve a particular pose within the parking space 312 and/or park within a threshold distance of a boundary (e.g., boundary 320, boundary 322, and/or boundary 324) of the parking space 312.

Once the local computing device 110 of the AV 102 has identified the switching point 330, the local computing device 110 of the AV 102 can use the switching point 330 to trigger a switch to the specialized planner used by the AV 102 to park in the parking space 312. In some cases, the local computing device 110 of the AV 102 can trigger the switch to the specialized planner when the AV 102 is located at the switching point 330 (and/or when a portion of the AV 102 reaches the switching point 330), when the AV 102 is within a threshold distance from the switching point 330, at a certain amount of time prior to when the AV 102 is predicted to reach or arrive at the switching point 330, at a certain amount of time after the AV 102 is predicted to reach or arrive at the switching point 330, or at a certain amount of time before or after the AV 102 is predicted to achieve or reach a pose relative to the switching point 330. In some cases, the local computing device 110 of the AV 102 can trigger (or plan) the switch to the specialized planner when the AV 102 is (or is predicted to be) within a range of locations relative to the switching point 330 (including or excluding the location of the switching point 330) and/or the AV 102 is (or is predicted to be) within a range of orientations relative to the switching point 330 (including or excluding an orientation of the switching point 330, if any).

In some examples, to identify the switching point 330 and/or to perform the parallel parking maneuver to park within the parking space 312, the AV 102 can collect data from one or more sensors and/or receivers of the AV 102 (e.g., a camera sensor, a LIDAR, a RADAR, an infrared sensor, a GPS/GNSS receiver, a wireless sensor, an acoustic sensor (e.g., an ultrasonic sensor, a microphone, etc.), an inertial measurement unit (IMU), a steering wheel sensor or decoder, an accelerometer (e.g., in addition to or in lieu of the IMU), a depth sensor such as a time-of-flight (TOF) sensor, and/or any other sensor or receiver), and use the data to understand the scene 300 (e.g., detect/recognize semantic elements of the scene 300, detect objects in the scene 300, determine geometries of one or more aspects/elements of the scene 300, determine a location and/or orientation of the AV 102 within the scene 300, determine one or more rules and/or restrictions of the scene 300, etc.), identify the switching point 330, detect the parking space 312 (and an associated occupancy state), detect one or more boundaries of the parking space 312 (e.g., boundary 320, 322, and/or 324), detect one or more other parking spaces (and associated boundaries and/or occupancy states), and/or perform the parallel parking maneuver (e.g., guide the AV 102 to a parked position within the parking space 312 and/or from a position relative to the switching point 330 to the parked position within the parking space 312).

For example, the AV 102 can use data from one or more sensors and/or receivers (e.g., location data such as coordinates from a sensor, GPS/GNSS data, LIDAR data, RADAR data, acoustic data, infrared data, wireless device data (e.g., localization and/or mapping data from a wireless device such as a WIFI and/or cellular device), acceleration/deceleration measurements, speed and/or velocity measurements, steering and/or steering wheel angle measurements, orientation measurements, depth measurements, proximity measurements, object detection and/or recognition outputs, heading measurements and/or estimates, etc.) to understand the scene 300. To illustrate, the AV 102 can use the data to detect the parking spaces 310-314, an occupancy state of the parking spaces 310-314, the vehicles 306-308, the boundaries 320-324 of the parking space 312, a geometry of any of the parking spaces 310-314, a geometry of any portion(s) of the driving area 302, detect any objects and/or other vehicles in the scene 300, detect any pedestrians in the scene 300, determine one or more traffic rules in the scene 300, determine any conditions in the scene 300, determine any semantic elements in the scene 300, determine an orientation of any of the parking spaces 310-314, and/or determine any other aspects and/or features of the scene 300. The AV 102 can use such information, for example, to determine the switching point 330, as previously described, select the parking space 312, navigate to the switching point 330, trigger a switch to the specialized planner, and/or guide the AV 102 from the switching point 330 to a parked position within the parking space 312. In some cases, the AV 102 can use such information and any additional information such as, for example and without limitation, one or more measurements of the AV 102 (e.g., location and/or orientation measurements of the AV 102, motion measurements of the AV 102, etc.), map data, traffic data, and/or other data.

In some aspects, the local computing device 110 of the AV 102 can use the data from one or more sensors and/or devices to determine the switching point 330, trigger (and/or plan) a switch to the specialized planner (from another planner) based on the switching point 330 and a status/state of the AV 102 (e.g., a location of the AV 102, an orientation of the AV 102, a speed of the AV 102, a trajectory and/or velocity of the AV 102, a deceleration/acceleration of the AV 102, a heading of the AV 102, etc.), navigate to the parking space 312 and guide the AV 102 into the parking space 312.

For example, the local computing device 110 of the AV 102 can use the data from one or more sensors and/or devices to navigate the AV 102 to the switching point 330. The local computing device 110 of the AV 102 can use the data to detect that the AV 102 has reached the switching point 330, and autonomously switch to the specialized planner used by the AV 102 to park in the parking space 312. The specialized planner can determine, receive from another component of the AV 102 (e.g., perception stack 112, localization stack 114, prediction stack 116, etc.), or receive from a human controller (e.g., human controller 210) a distance between the AV 102 and the parking space 312 (e.g., a distance between the AV 102 and an estimated parked location within the parking space 312, any of the boundaries of the parking space 312, etc.), the distance between the AV 102 and any other vehicles (e.g., vehicle 306, vehicle 308, and/or any other vehicles) and/or objects, an orientation of the AV 102 relative to an orientation of the parking space 312 and/or a predicted orientation of the AV 102 when parked at the parking space 312, and/or a predicted position of the AV 102 when parked at the parking space 312. In some cases, the specialized planner can determine, based on such information, an estimated path from the position of the AV 102 to the predicted position of the AV 102 when parked at the parking space 312 or receive the estimated path from another component of the local computing device 110 of the AV 102.

In some examples, based on such information, the specialized planner can determine the estimated path of the AV 102 to the predicted position of the AV 102 when parked at the parking space 312 and one or more maneuvers estimated to navigate the AV 102 along the estimated path to the predicted position of the AV 102 when parked at the parking space 312. The one or more maneuvers can include, for example, one or more steering angles (or steering wheel angles) and/or changes in steering angles (or steering wheel angles), a curvature of the estimated path at one or more locations along the estimated path, a reverse acceleration of the AV 102 at one or more points within the estimated path, any stopping and/or deceleration of the AV 102 at one or more points within the estimated path, a speed of the AV 102 at one or more points along the estimated path, a direction or heading of the AV 102 at one or more points along the estimated path, and/or a predicted pose of the AV 102 when parked at the parking space 312. The AV 102 can use this information to perform the parking maneuver and park at the parking space 312.

In some examples, the specialized planner can determine the estimated path of the AV 102 to the predicted position of the AV 102 when parked at the parking space 312 and/or one or more maneuvers to navigate the AV 102 along the estimated path to the predicted position of the AV 102 when parked at the parking space 312 based on data from a human controller 210 (e.g., from a device of a human controller 210). For example, the specialized planner can receive data specifying and/or used to determine the estimated path of the AV 102 to the predicted position of the AV 102 when parked at the parking space 312 and/or one or more maneuvers to navigate the AV 102 along the estimated path to the predicted position of the AV 102 when parked at the parking space 312 from a device of a human controller 210. In some cases, the specialized planner can additionally or alternatively receive, from a device of a human controller 210, one or more parameters, settings, rules, restrictions, permissions, and/or instructions to navigate and/or determine the estimated path of the AV 102 to the predicted position of the AV 102 when parked at the parking space 312 and/or one or more maneuvers to navigate the AV 102 along the estimated path to the predicted position of the AV 102 when parked at the parking space 312.

In some cases, the AV 102 can collect sensor data as it performs the park maneuver to park in the parking space 312, and use the sensor data to guide the AV 102 as it parks in the parking space 312. For example, the specialized planner can use the sensor data to instruct the AV 102 on any parameters and/or changes in parameters (e.g., speed, acceleration/deceleration, steering angle and/or steering wheel angle, direction/heading, etc.) to implement while parking in the parking space 312 to help guide the AV 102 to a parked position within the parking space 312.

FIG. 3B is a diagram illustrating another example use case for implementing a specialized planner (e.g., specialized planner 204) of the AV 102 to park the AV 102 in a scene 340. The use case in this example includes different type of parking spaces and a different type of parking maneuver used to park in the parking spaces than the use case in the example shown in FIG. 3A. For example, in the previous use case shown in FIG. 3A, the parking spaces in the scene 300 are configured for vehicles to park parallel/adjacent to a boundary (e.g., boundary 324) shared by the parking spaces, a boundary (e.g., boundary 304) of the driving area 302, vehicles navigating in the driving area 302 (e.g., in one direction or in opposite directions), and/or a directionality (e.g., a one-way direction of travel) or multiple directionalities (e.g., a two-way directionality that allows vehicles to travel in one direction and an opposite direction) of the driving area 302. Thus, given the configuration of the parking spaces in the scene 300 shown in FIG. 3A, the AV 102 and the specialized planner implemented by the AV 102 may, in some cases, need to be able to perform a parallel parking maneuver to park in a parking space in the scene 300, such as parking space 312.

On the other hand, in this example use case shown in FIG. 3B, the parking spaces 342-346 in the scene 340 are configured at an angle that is perpendicular to (e.g., at a perpendicular angle or within a threshold angle relative to a perpendicular angle) relative to a boundary 354 shared by the parking spaces 342-346, the boundary 304 of the driving area 302, vehicles navigating in the driving area 302 (e.g., in one direction or in opposite directions), and/or a directionality (e.g., a one-way direction of travel) or multiple directionalities (e.g., a two-way directionality that allows vehicles to travel in one direction and an opposite direction) of the driving area 302. Thus, given the configuration of the parking spaces 342-346 in the scene 340 shown in FIG. 3B, the AV 102 and the specialized planner implemented by the AV 102 may park in a parking space in the scene 340, such as parking space 344, by turning into the parking space (without having to parallel park).

As shown in FIG. 3B, the scene 340 includes the driving area 302 and the boundary 304 of the driving area 302, as previously described. The parking spaces 342-346 in the scene 340 are perpendicular to vehicles navigating the driving area 302 and/or a directionality (e.g., a one-way directionality) or directionalities (e.g., a two-way directionality for vehicles to travel in opposite directions) of the driving area 302. In this example, based on the configuration of the parking spaces 342-346, vehicles can park in the parking spaces 342-346 at an angle that is perpendicular to (or within a threshold angle to an angle that is perpendicular to) vehicles navigating in the driving area 302 and/or a directionality (e.g., a one-way directionality) or directionalities (e.g., a two-way directionality for vehicles to travel in opposite directions) of the driving area 302. For example, when parked at the parking spaces 342-346, a front or rear of the parked vehicles (e.g., the vehicle 306, AV 102, and the vehicle 308) can be facing towards (or within a threshold angle of) the boundary 354 of the parking spaces 342-346, as opposed to facing in a direction that is parallel to (or in a direction that is within a threshold angle of a parallel direction) of the boundary 354 as illustrated by the parking spaces 310-314 in the scene 300 shown in FIG. 3A. Accordingly, the specialized planner can perform a different maneuver to park in a parking space in the scene 340 than a parking space in the scene 300 in FIG. 3A.

For example, to park in the parking spaces 342-346 in the scene 340, vehicles can turn into the parking spaces 342-346 from the driving area 302. To illustrate, the specialized planner of the AV 102 may determine that the AV 102 may travel in a forward direction in the driving area 302 and turn from the driving area 302 into the parking space 344 to park in the parking space 344. Alternatively, the specialized planner of the AV 102 may determine that the AV 102 may travel in a forward direction in the driving area 302 to a position ahead of the parking space 344 (e.g., to a position passed the parking space 344) and back into the parking space 344 by reversing from the position ahead of the parking space 344 and turning at a certain angle(s) while reversing into the parking space 344.

In some examples, the specialized planner of the AV 102 may determine that a pose of the AV 102 when parked at the parking space 344 (e.g., a final pose or a destination pose achieved when a parking maneuver is complete) can be perpendicular to (or within a threshold angle relative to an angle that is perpendicular to) a pose of the AV 102 when the AV 102 navigates the driving area 302 and/or when the AV 102 is in the driving area 302 at a position relative to the parking space 344 (e.g., a position ahead of the parking space 344 if the AV 102 intends to reverse into the parking space 344, or a position behind the parking space 344 if the AV 102 intends to turn into the parking space 344 while moving forward at an angle(s)) prior to the AV 102 turning into the parking space 344.

Before parking at the parking space 344, the local computing device 110 of the AV 102 may use sensor data to detect the parking space 344, the boundaries 350-352 of the parking space 344, and an occupancy state of the parking space 344 (e.g., occupied by a vehicle or object, unoccupied by any vehicles or objects, etc.). Based on an unoccupied state of the parking space 344, the local computing device 110 of the AV 102 may select the parking space 344 to park the AV 102. The local computing device 110 of the AV 102 may identify a point in time and/or space to switch to the specialized planner to park the AV 102 in the parking space 344. To illustrate, in the example of FIG. 3B, the local computing device 110 of the AV 102 may identify the switching point 360 and trigger a switch to the specialized planner when the AV 102 reaches the switching point 360 (or when the AV 102 is within a threshold proximity to the switching point 360 and/or a threshold amount of time until the AV 102 is predicted to reach the switching point 360).

In some examples, the switching point 360 can refer to a location and/or orientation of the AV 102 at a certain time when approaching the parking space 344, and/or a location, distance, and/or orientation of the AV 102 relative to one or more reference points such as, for example and without limitation, the parking space 344, the boundary 350 (e.g., the location and/or orientation of the boundary 350) of the parking space 344, the boundary 352 (e.g., the location and/or orientation of the boundary 352) of the parking space 344, the boundary 354 (e.g., the location and/or orientation of the boundary 354) of the parking space 344, the vehicle 306 in the parking space 342 and/or the vehicle 308 in the parking space 346, a predicted (and/or desired) pose of the AV 102 when the AV 102 completes parking in the parking space 344, an area or point within the parking space 344 (e.g., a center of the parking space, an end of the parking space, etc.), and/or relative to any other reference point(s).

In some cases, the switching point 360 can include a location and/or orientation that the AV 102 may need to reach to complete the parking maneuver to park in the parking space 344 and achieve a certain pose/location within the parking space 344 in a certain number of maneuvers such as, for example, a certain number of turning, stopping, acceleration, and/or deceleration maneuvers and/or a certain number of changes in a direction of travel and/or steering angle (or steering wheel angle) of the AV 102, an acceleration of the AV 102, a deceleration of the AV 102, a pose of the AV 102, a speed of the AV 102, and/or any other state/status of the AV 102. For example, if the local computing device 110 of the AV 102 chooses to perform the parking maneuver to park the AV 102 in the parking space 344 as a single maneuver (e.g., a perpendicular parking maneuver performed without stopping the AV 102 from a beginning to an end of the perpendicular parking maneuver), the switching point 360 can include a position (e.g., location and/or orientation) of the AV 102 that the local computing device 110 of the AV 102 estimates the AV 102 needs to have at a start of the perpendicular parking maneuver in order to complete the perpendicular parking maneuver as a single maneuver or within a single maneuver.

As another example, if the local computing device 110 of the AV 102 chooses to perform the perpendicular parking as a sequence (or continuous sequence) of maneuvers (e.g., as a sequence of changes in acceleration, deceleration, direction and/or angle of travel/turning (e.g., a steering or steering wheel angle, a curvature of a path, etc.) with or without stopping the AV 102 from a beginning to an end of the sequence (or continuous sequence) of maneuvers), the switching point 360 can include a position (e.g., location and/or orientation) of the AV 102 that the local computing device 110 of the AV 102 estimates the AV 102 needs to have at a start of the perpendicular parking in order to complete the perpendicular parking as or within the sequence (or continuous sequence) of maneuvers.

As yet another example, if the local computing device 110 of the AV 102 chooses to complete the perpendicular parking into the parking space 344 within a specific amount of time, the switching point 360 can include a position (e.g., location and/or orientation) of the AV 102 that the local computing device 110 of the AV 102 estimates the AV 102 needs to have when starting the perpendicular parking maneuver in order to complete the perpendicular parking into the parking space 344 within the specific amount of time.

In some cases, the switching point 360 can additionally or alternatively include a position (e.g., location and/or orientation) of the AV 102 that the local computing device 110 of the AV 102 estimates the AV 102 needs to have in order to perform the perpendicular parking maneuver without exceeding a particular metric(s) and/or constraint(s) such as, for example and without limitation, a performance metric, a safety metric, a distance metric, a pose metric, a collision buffer constraint (e.g., a minimum amount of distance between the AV 102 and the vehicle 306, the vehicle 308, and/or other vehicles in the scene 340), a steering angle (or range of steering angles) and/or steering wheel angle (and/or range of steering wheel angles), a minimum speed, a maximum speed, a maximum turning angle, a minimum distance, a maximum distance, and/or any other metrics and/or constraints. For example, the switching point 360 can include a position that the AV 102 needs to have to perform and complete the perpendicular parking maneuver while maintaining at least a threshold distance to other vehicles (e.g., vehicle 306, vehicle 308, other vehicles, etc.) during the perpendicular parking maneuver and/or at the end of the perpendicular parking maneuver. As another example, the switching point 360 can include a position that the AV 102 needs to have to achieve a particular pose within the parking space 344 and/or park within a threshold distance of a boundary (e.g., boundary 350, boundary 352, and/or boundary 354) of the parking space 344.

Once the local computing device 110 of the AV 102 has identified the switching point 360, the local computing device 110 of the AV 102 can use the switching point 360 to trigger a switch to the specialized planner used by the AV 102 to park in the parking space 344. In some cases, the local computing device 110 of the AV 102 can trigger the switch to the specialized planner when the AV 102 is located at the switching point 360 (and/or when a portion of the AV 102 reaches the switching point 360), when the AV 102 is within a threshold distance from the switching point 360, at a certain amount of time prior to when the AV 102 is predicted to reach or arrive at the switching point 360, at a certain amount of time after the AV 102 is predicted to reach or arrive at the switching point 360, or at a certain amount of time before or after the AV 102 is predicted to achieve or reach a pose relative to the switching point 360. In some cases, the local computing device 110 of the AV 102 can trigger (or plan) the switch to the specialized planner when the AV 102 is (or is predicted to be) within a range of locations relative to the switching point 360 (including or excluding the location of the switching point 360) and/or the AV 102 is (or is predicted to be) within a range of orientations relative to the switching point 360 (including or excluding an orientation of the switching point 360, if any).

In some examples, to identify the switching point 360 and/or to perform the perpendicular parking maneuver to park within the parking space 344, the AV 102 can collect data from one or more sensors and/or receivers of the AV 102 (e.g., a camera sensor, a LIDAR, a RADAR, an infrared sensor, a GPS/GNSS receiver, a wireless sensor, an acoustic sensor (e.g., an ultrasonic sensor, a microphone, etc.), an inertial measurement unit (IMU), a steering wheel sensor or decoder, an accelerometer (e.g., in addition to or in lieu of the IMU), a depth sensor such as a time-of-flight (TOF) sensor, and/or any other sensor or receiver), and use the data to understand the scene 340 (e.g., detect/recognize semantic elements of the scene 340, detect objects in the scene 340, determine geometries of one or more aspects/elements of the scene 340, determine a location and/or orientation of the AV 102 within the scene 340, determine one or more rules and/or restrictions of the scene 340, etc.), identify the switching point 360, detect the parking space 344 (and an associated occupancy state), detect one or more boundaries of the parking space 344 (e.g., boundary 350, 352, and/or 354), detect one or more other parking spaces (and associated boundaries and/or occupancy states), and/or perform the perpendicular parking maneuver (e.g., guide the AV 102 to a parked position within the parking space 344 and/or from a position relative to the switching point 360 to the parked position within the parking space 344).

For example, the AV 102 can use data from one or more sensors and/or receivers (e.g., location data such as coordinates from a sensor, GPS/GNSS data, LIDAR data, RADAR data, acoustic data, infrared data, wireless device data (e.g., localization and/or mapping data from a wireless device such as a WIFI and/or cellular device), acceleration/deceleration measurements, speed and/or velocity measurements, steering and/or steering wheel angle measurements, orientation measurements, depth measurements, proximity measurements, object detection and/or recognition outputs, heading measurements and/or estimates, etc.) to understand the scene 340. To illustrate, the AV 102 can use the data to detect the parking spaces 342-246, an occupancy state of the parking spaces 342-346, the vehicles 306-308, the boundaries 350-354 of the parking space 344, a geometry of any of the parking spaces 350-354, a geometry of any portion(s) of the driving area 302, detect any objects and/or other vehicles in the scene 340, detect any pedestrians in the scene 340, determine one or more traffic rules in the scene 340, determine any conditions in the scene 340, determine any semantic elements in the scene 340, determine an orientation of any of the parking spaces 342-346, and/or determine any other aspects and/or features of the scene 340.

The AV 102 can use such information, for example, to determine the switching point 360 as previously described, select the parking space 344, navigate to the switching point 360, trigger a switch to the specialized planner, and/or guide the AV 102 from the switching point 360 to a parked position within the parking space 344. In some cases, the AV 102 can use such information and any additional information such as, for example and without limitation, one or more measurements of the AV 102 (e.g., location and/or orientation measurements of the AV 102, motion measurements of the AV 102, etc.), map data, traffic data, and/or other data.

In some aspects, the local computing device 110 of the AV 102 can use the data from one or more sensors and/or devices to determine the switching point 360, trigger (and/or plan) a switch to the specialized planner (from another planner) based on the switching point 360 and a status/state of the AV 102 (e.g., a location of the AV 102, an orientation of the AV 102, a speed of the AV 102, a trajectory and/or velocity of the AV 102, a deceleration/acceleration of the AV 102, a heading of the AV 102, etc.), navigate to the parking space 344 and guide the AV 102 into the parking space 344.

For example, the local computing device 110 of the AV 102 can use the data from one or more sensors and/or devices to navigate the AV 102 to the switching point 360. The local computing device 110 of the AV 102 can use the data to detect that the AV 102 has reached the switching point 360, and autonomously switch to the specialized planner used by the AV 102 to park in the parking space 344. The specialized planner can determine, receive from another component of the AV 102 (e.g., perception stack 112, localization stack 114, prediction stack 116, etc.), or receive from a human controller (e.g., human controller 210) a distance between the AV 102 and the parking space 344 (e.g., a distance between the AV 102 and an estimated parked location within the parking space 344, any of the boundaries of the parking space 344, etc.), the distance between the AV 102 and any other vehicles (e.g., vehicle 306, vehicle 308, and/or any other vehicles) and/or objects, an orientation of the AV 102 relative to the parking space 344 and/or an orientation of the parking space 344, an pose of the AV 102 relative to a predicted pose of the AV 102 when parked at the parking space 344, and/or a predicted distance of the AV 102 to one or more elements in the scene 340 when the AV 102 is parked at the parking space 344.

In some cases, the specialized planner can determine, based on such information, an estimated path from the position of the AV 102 to the predicted position of the AV 102 when parked at the parking space 344 or receive the estimated path from another component of the local computing device 110 of the AV 102. In some examples, based on such information, the specialized planner can determine the estimated path of the AV 102 to the predicted position of the AV 102 when parked at the parking space 344 and one or more maneuvers estimated to navigate the AV 102 along the estimated path to the predicted position of the AV 102 when parked at the parking space 344.

For example, the specialized planner can determine an estimated path of the AV 102 from the driving area 302 (e.g., from a switching point 360, from a position of the AV 102 relative to the switching point 360, and/or from a position of the AV 102 relative to the parking space 344) to a pose of the AV 102 within the parking space 344 when the AV 102 completes parking in the parking space 344 (e.g., an estimated path in a forward direction when turning into the parking space 344 or a backward direction when reversing into the parking space 344). The specialized planner can determine one or more maneuvers and/or parameters to guide the AV 102 along the estimated path from the driving area 302 to the pose of the AV 102 within the parking space 344 when the AV 102 completes parking in the parking space 344. To illustrate, the specialized planner can determine one or more turns (e.g., steering angles and/or steering wheel angles) and/or turning angles, one or more turning points, one or more acceleration/deceleration points (e.g., start and end points, etc.), one or more acceleration/deceleration distances, one or more forward or reverse travel directions, one or more forward or reverse travel distances, one or more speeds, and/or one or more stops that the AV 102 may perform at one or more points in time and/or space to travel along the estimated path of the AV 102 from the driving area 302 to the pose of the AV 102 within the parking space 344 when the AV 102 completes parking in the parking space 344. The AV 102 can perform such maneuvers to park in the parking space 344.

In some cases, the one or more maneuvers selected (and/or estimated) by the specialized planner to perform the perpendicular parking maneuver to park in the parking space 344 can include, for example and without limitation, one or more steering angles (and/or steering wheel angles) and/or changes in steering angles (and/or steering wheel angles), a curvature of the estimated path at one or more locations along the estimated path, an acceleration (reverse or forward) of the AV 102 at one or more points within the estimated path, any stopping and/or deceleration of the AV 102 at one or more points within the estimated path, a speed of the AV 102 at one or more points along the estimated path, a direction or heading of the AV 102 at one or more points along the estimated path, and/or a predicted or desired pose of the AV 102 when parked at the parking space 344. The AV 102 can use this information to perform the parking maneuver and park at the parking space 344.

In some cases, the AV 102 can collect sensor data as it performs the park maneuver to park in the parking space 344, and use the sensor data to guide the AV 102 as it parks in the parking space 344. For example, the specialized planner can use the sensor data to instruct the AV 102 on any parameters and/or changes in parameters (e.g., speed, acceleration/deceleration, steering angle and/or steering wheel angle, direction/heading, etc.) to implement while parking in the parking space 344 to help guide the AV 102 to a parked position within the parking space 344.

While the scene 300 in FIG. 3A illustrates parallel parking spaces and the scene 340 in FIG. 3B illustrates perpendicular (or right angle) parking spaces, such spaces are merely illustrative examples provided for explanation purposes. In other examples, the specialized planner can be implemented to park in other types of parking spaces such as, for example and without limitation, angle parking spaces, street parking spaces, off-street parking spaces, thirty-degree parking (also 30 parking), multi-level parking, etc.

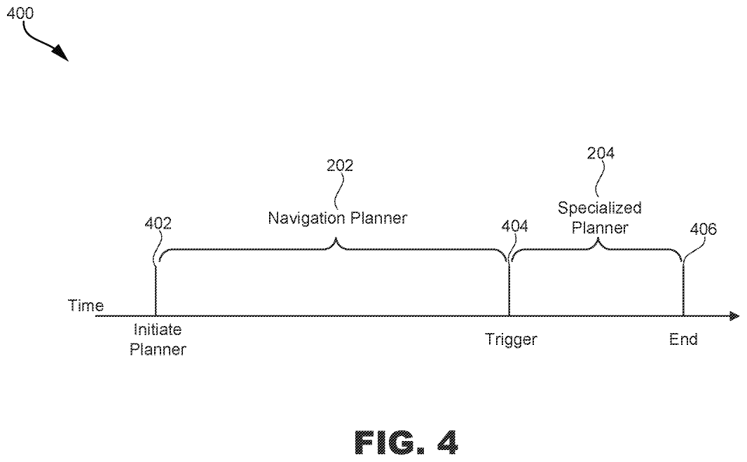

FIG. 4 illustrates an example timeline 400 for switching planners implemented by an AV, such as AV 102. In this example, the AV 102 can initialize 402 the navigation planner 202 to navigate one or more scenes. The AV 102 can use the navigation planner 202 to navigate the one or more scenes until the AV 102 needs to switch to a different planner, such as the specialized planner 204.

While using the navigation planner 202 to navigate one or more scenes, the AV 102 can detect a trigger 404 that the AV 102 can use to switch to the specialized planner 204 and/or that the AV 102 recognizes as a cue for switching to the specialized planner 204. The trigger 404 can include, for example, a change in a type of scene where the AV 102 is located and/or that the AV 102 needs to navigate and/or operate in, such as a change to a type of scene associated with the specialized planner 204 and/or a change to a type of scene in which the AV 102 may need to deviate from one or more parameters (e.g., a collision buffer parameter, a speed parameter, a behavior parameter, a pose parameter, a merge parameter, a yield parameter, a steering angle and/or steering wheel angle parameter, etc.) of the navigation planner 202 to navigate in that scene. In some cases, the trigger 404 can additionally or alternatively include, for example and without limitation, identifying and/or planning a particular maneuver associated with the specialized planner 204 (e.g., parking, merging, etc.) that the AV 102 needs to (and/or intends to) perform, identifying one or more parameters associated with the specialized planner 204 that the AV 102 needs to (and/or intends to) implement, determining that the AV 102 needs to (and/or intends to) deviate from one or more restrictions of the navigation planner 202 to navigate a particular scene and/or perform a particular maneuver, determining one or more conditions associated with the specialized planner 204 present in a scene of the AV 102 and/or relevant to a maneuver that the AV 102 plans to perform, determining one or more capabilities needed by the AV 102 to navigate a scene and/or perform a maneuver are supported by the specialized planner 204, and/or determine a context of the AV 102 is associated with the specialized planner 204.

The local computing device 110 of the AV 102 can use the trigger 404 to switch from the navigation planner 202 to the specialized planner 204. In some cases, the AV 102 can switch to the specialized planner 204 in response to (and/or at a time of) detecting the trigger 404. In some cases, the AV 102 can use the trigger 404 to determine a point in time and/or space when the AV 102 should switch to the specialized planner 204. For example, the AV 102 can detect the trigger 404 and determine that it needs to switch to the specialized planner 204. The AV 102 can then determine a particular point in space (e.g., a location and/or orientation of the AV 102) and/or time to switch to the specialized planner 204 based on a position of the AV 102 and a predicted position of the AV 102 when the AV 102 needs to begin navigating a scene associated with the specialized planner 204 and/or performing a maneuver associated with the specialized planner 204. In some examples, the AV 102 can determine the predicted position of the AV 102 when the AV 102 needs to begin navigating and/or performing the maneuver based on a speed of the AV 102, a trajectory of the AV 102, the pose of the AV 102, a configuration of a scene of the AV 102, a detection of one or more semantic elements in a scene of the AV 102, a predicted change in state/status of the AV 102 and/or another scene element (e.g., another vehicle, a pedestrian, a bicycle, a motorcycle, etc.), one or more capabilities of the AV 102 (e.g., hardware, software, and/or mechanical capabilities), one or more conditions in a scene of the AV 102, and/or one or more predetermined rules and/or parameters.

After the trigger 404, the AV 102 can switch to the specialized planner 204 and use the specialized planner 204 to navigate a scene associated with the specialized planner 204 and/or perform a maneuver(s) associated with the specialized planner 204. For example, the AV 102 can use the specialized planner 204 to park in a parking space or a particular location, perform a certain lane merge in a scene, navigate a cul-de-sac, etc. The AV 102 can use planning data from the specialized planner 204 to navigate the scene associated with the specialized planner 204 and/or perform the maneuver(s) associated with the specialized planner 204.

In some examples, the specialized planner 204 can use sensor data from one or more sensors of the AV 102 to generate planning data (e.g., outputs 220). In some cases, the specialized planner 204 can additionally or alternatively use perception data (e.g., from perception stack 112), localization data (e.g., from localization stack 114), prediction data (e.g., from prediction stack 116), and/or tracking data to generate the planning data. In some cases, the specialized planner 204 can additionally or alternatively use data from a human controller (e.g., human controller 210), as previously explained. The planning data can include plans, settings, rules, parameters, and/or instructions for navigating a scene, performing a maneuver(s), etc.

In some cases, the AV 102 can use the navigation planner 202 to reach a location and/or orientation where the AV 102 is to begin an operation and/or maneuver(s) that will be performed by the AV 102 using the specialized planner 204. For example, the AV 102 can use the navigation planner 202 to obtain a starting location and/or orientation for implementing the specialized planner 204. Once the AV 102 reaches the starting location and/or orientation using the navigation planner 202, the AV 102 can use the specialized planner 204 to navigate the AV 102 and/or perform a maneuver(s) from the starting location and/or orientation.

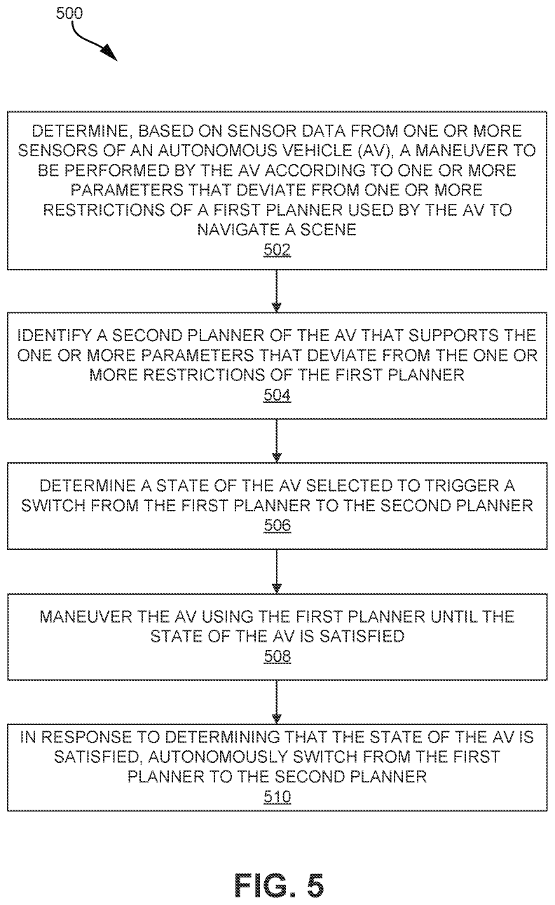

FIG. 5 is a flowchart illustrating an example process 500 for implementing different planners for autonomous driving. At block 502, the process 500 can include determining, based on sensor data from one or more sensors of an autonomous vehicle (AV) (e.g., AV 102), a maneuver to be performed by the AV according to one or more parameters that deviate from one or more restrictions of a first planner (e.g., navigation planner 202) being used by the AV to navigate a scene (e.g., scene 300, scene 340, etc.). The one or more parameters can include a parameter relating to a behavior, maneuver, operation, and/or state/status of the AV that exceeds, violates, and/or otherwise deviates from the one or more restrictions of the first planner.

The one or more restrictions of the first planner can include, for example and without limitation, a collision buffer restriction (e.g., a restriction specifying a minimum distance to have and/or maintain between the AV and other scene elements such as vehicles, bicycles, motorcycles, pedestrians, animals, objects, semantic elements and/or associated boundaries, etc.), a steering angle restriction and/or steering wheel angle restriction, a speed restriction and/or speed range restriction, a behavior restriction (e.g., stopping at a certain location, performing a certain sequence of maneuvers, traveling or moving in a certain direction such as a reverse direction, etc.), a traffic restriction, a pose restriction (e.g., a restriction of a pose of the AV relative to other scene elements such as another vehicle, a traffic marking, a traffic sign, a semantic element, etc.), a restriction on a curvature of a path of travel/motion, etc.

In some cases, the one or more restrictions can include a dependency of the first planner, such as an attribute, condition, requirement, and/or element that needs to be present for the first planner to operate (and/or to perform certain operations, behaviors, etc.) and/or that the first planner relies on to operate (and/or to perform certain operations, behaviors, etc.). For example, the one or more restrictions can include a lane and/or lane boundaries dependency meaning that the scene in which the first planner is implemented by the AV needs to have a lane(s) and associated lane boundaries. The first planner may rely on when performing planning operations for navigating the AV in such a scene, the first planner may use or need to use the lane(s) and associated lane boundaries to navigate the AV in such a scene, and/or the first planner may use, rely on, or need to use the lane(s) and associated lane boundaries to generate planning data/outputs that the AV uses to navigating such scene.

To illustrate, a parking garage may not include predefined and/or premapped lanes and/or lane boundaries, a map used by the first planner to navigate in the parking garage may not included information about lanes and/or lane boundaries in the parking garage, and/or the AV may not have a map of the parking garage and thus may lack information about lanes and lane boundaries in the parking garage. In this example, the first planner may not be able to navigate the parking garage without information about lanes and/or lane boundaries in the parking garage. Thus, a dependency of the first planner may include information about lane and/or lane boundaries in the parking garage. Accordingly, in this example, if the maneuver in block 502 includes navigating in the parking garage and the one or more parameters include parameters for navigating in the parking garage, such maneuver may need to operate according to parameters that deviate from one or more restrictions of the first planner (e.g., navigating in a parking garage that lacks lanes and/or associated lane boundaries and/or in a parking garage for which the AV does not have information about lanes and/or associated lane boundaries), such as a dependency (e.g., a presence of lanes and/or lane boundaries in the parking garage and/or information about lanes and/or associated lane boundaries).

As another example, the one or more restrictions can include a map data dependency. The map data dependency can include a need, requirement, and/or reliance on a map of a scene (e.g., a semantic map, a scene map, a navigation map, etc.) that would be used by the first planner to navigate the scene. Here, the first planner may be configured to operate in environments that are mapped, have associated navigation and/or semantic maps, and/or have certain (or any) map data in a map that the first planner may need and/or rely on to navigate the AV in such environments and/or provide the AV information used by the AV to operate in such environments. To illustrate, the parking garage in the previous example may not be mapped in a map of the AV, may not be described in the map of the AV (e.g., through semantic elements in the parking garage that are identified in the map, rules of the parking garage identified in the map, navigation information (e.g., lanes, routes, directionality, boundaries, ramps, etc.) that the AV (e.g., the first planner) may use to navigate the parking garage, etc.), and/or may not have an associated map that the AV may use to navigate the parking garage. For example, without the map, the first planner may not be able to navigate the AV in the parking garage. If the maneuver in block 502 includes navigating in the parking garage and the parameters include parameters for navigating in the parking garage despite the lacking map information associated with the parking garage, the local computing device (e.g., local computing device 110) may determine that such parameters for navigating the parking garage deviate from one or more restrictions of the first planner (e.g., a dependency of associated map data).

In yet another example, the maneuver can include a parking maneuver and the parameters that deviate from one or more restrictions of the first planner can include a steering angle(s) and/or steering wheel angle(s) parameter, a parameter corresponding to a curvature of a path from a position of the AV relative to a parking space to a position of the AV within the parking space, a pose parameter corresponding to a pose of the AV in a parked position within a parking space, and/or a parameter for one or more behaviors implemented during (and/or as part of) the parking maneuver. In this example, such parameter can deviate from one or more restrictions of the first planner. To illustrate, a steering angle(s) and/or steering wheel angle(s) parameter can exceed a maximum steering angle and/or steering wheel angle defined for the first planner, the curvature associated with a parameter for a curvature of a path the AV can follow to a parked position within a parking space can exceed a maximum curvature defined for the first planner, a pose parameter can include a location and/or orientation that is not permitted by a pose restriction of the first planner (and/or exceeds a pose parameter, falls outside of a pose parameter range, etc.), and/or a parameter for one or more behaviors implemented to perform the parking maneuver exceed, violate, and/or is not within a range of one or more parameters of the first planner associated with the one or more behaviors.

At block 504, the process 500 can include identifying a second planner (e.g., specialized planner 204) of the AV that supports the one or more parameters that deviate from the one or more restrictions of the first planner. For example, the local computing device 110 of the AV 102 can identify which of a set of planners of the AV 102 supports the one or more parameters (e.g., can implement the one or more parameters), allows the one or more parameters to be implemented, and/or lack the one or more restrictions that would prevent the one or more parameters from being implemented/followed.

In some examples, the first planner can be configured to navigate scenes containing lanes defined with lane boundaries and the maneuver can include navigating other scenes that do not contain lanes defined with lane boundaries. In this example, the second planner can be configured to perform (and/or support and/or allow/enable) such maneuver (e.g., navigate other scenes that do not contain lanes defined with lane boundaries). In some cases, the maneuver can include a parking maneuver and/or navigating the AV around a cul-de-sac, which may involve implementing one or more parameters that deviate from (e.g., conflict with, are prohibited by, exceed, do not satisfy, etc.) one or more restrictions of the first planner. In this example, the second planner can include a planner configured to perform such maneuver, implement the one or more parameters, and/or to avoid, ignore, and/or lack the one or more restrictions of the first planner.

In some cases, the one or more restrictions of the first planner can include a collision buffer restriction that defines a minimum distance that the AV needs to maintain from other vehicles (and/or other items in a scene), and the one or more parameters supported by the second planner can allow the AV to reach and/or maintain a distance from other vehicles (and/or other items in the scene) that is less (e.g., the distance is less) than the minimum distance defined by the collision buffer restriction of the first planner.

In some aspects, identifying the second planner can include determining, based on the maneuver to be performed according to the one or more parameters and/or a context of the AV (e.g., a scene of the AV, a state and/or status of the AV, one or more maneuvers to be performed by the AV, a condition of the AV and/or in an environment of the AV, a capability of the AV, a limitation of the AV, a software of the AV, a hardware of the AV, a mechanical system of the AV, etc.), that the AV needs to deviate from the one or more restrictions of the first planner when performing the maneuver, determining that the second planner of the AV supports the maneuver and the one or more parameters that deviate from the one or more restrictions of the first planner and, in response to determining that the AV needs to deviate from the one or more restrictions of the first planner and determining that the second planner supports the maneuver and the one or more parameters that deviate from the one or more restrictions of the first planner, selecting to use the second planner to perform the maneuver (e.g., selecting the second planner for the maneuver).

At block 506, the process 500 can include determining a state of the AV selected to trigger a switch from the first planner to the second planner. Non-limiting examples of a state of the AV can include a location of the AV (and/or other things in a scene of the AV), an orientation of the AV (and/or other things in a scene of the AV), an acceleration of the AV (and/or other things in a scene of the AV), a deceleration of the AV (and/or other things in a scene of the AV), a heading and/or trajectory of the AV (and/or other things in a scene of the AV), a context of the AV (e.g., a scene, a status of the AV in relation to other things in the scene, a condition of the AV and/or the scene, etc.), a measurement of the AV (and/or other things in a scene of the AV), and/or a status of the AV (and/or other things in a scene of the AV).

In some cases, determining the state of the AV selected to trigger the switch to the second planner can include determining a location and/or orientation that the AV needs to reach/achieve in order to complete the maneuver in a certain number of steps or missions (e.g., a certain number of behaviors, maneuvers, segments, and/or operations) such as, for example, as a single step or mission (e.g., as a single maneuver, behavior, segment, and/or operation) or a predefined number of steps or missions. Once the AV achieves such state, the local computing device 110 of the AV 102 can trigger the switch to the second planner.

For example, in some aspects, determining the state of the AV selected to trigger the switch to the second planner can include determining a position that the AV needs to achieve to perform the maneuver as a single maneuver from a particular position of the AV prior to performing the single maneuver, and determining the state of the AV based on the position that the AV needs to achieve to perform the maneuver as the single maneuver from the particular position of the AV prior to performing the single maneuver.

In other aspects, determining the state of the AV selected to trigger the switch to the second planner can include determining a position that the AV needs to achieve to perform the maneuver as a continuous sequence of maneuvers from a particular position of the AV prior to performing the continuous sequence of maneuvers, and determining the state of the AV based on the position that the AV needs to achieve to perform the maneuver as the continuous sequence of maneuvers from the particular position of the AV prior to performing the continuous sequence of maneuvers.

At block 508, the process 500 can include maneuvering the AV using the first planner until the state of the AV is satisfied. For example, the AV 102 can use the first planner to maneuver the AV 102 in a scene until the AV 102 reaches the state that triggers the switch to the second planner. Once the local computing device 110 determines that the AV 102 has reached the state, the local computing device 110 can autonomously switch from the first planner to the second planner, which the AV 102 can use to perform the maneuver.

In an illustrative example, the state of the AV can include a particular location of the AV within a scene and/or a particular pose of the AV within the scene, and maneuvering the AV using the first planner until the state of the AV is satisfied can include navigating the AV to the particular location of the AV and/or the particular pose of the AV using the first planner. In this example, the local computing device 110 of the AV 102 can trigger the switch from the first planner to the second planner once the AV 102 achieves the particular location and/or the particular pose. The AV 102 can then use the second planner to perform the maneuver.

At block 510, the process 500 can include autonomously switching from the first planner to the second planner in response to determining that the state of the AV is satisfied. In some examples, the local computing device 110 of the AV 102 can switch to the second planner based on a determination that the state of the AV is satisfied (e.g., a determination that the AV has reached/achieved the state that triggers the switch). In some cases, the planning stack 118 can automatically perform the switch from the first planner to the second planner. In other cases, another stack, system, controller, model, algorithm, software, and/or component can automatically perform the switch to the second planner. For example, an algorithm on the local computing device 110 can be configured to detect the state of the AV (and/or verify the state of the AV) and automatically switch to the second planner. As another example, a model, such as a machine learning model or a neural network, can be configured to detect the state of the AV (and/or verify the state of the AV) and automatically switch to the second planner.

In some examples, switching from the first planner to the second planner can include setting the first planner as inactive and the second planner as active. In some cases, switching from the first planner to the second planner can include generating an instruction requesting the switch to the second planner and/or requesting use of the second planner to perform the maneuver. In some cases, switching from the first planner to the second planner can include generating a call and/or command to the second planner. The call and/or command to the second planner can be configured to trigger the second planner to take control of planning operations when performing the maneuver and/or activate the second planner.

In some aspects, the process 500 can include, after switching to the second planner, performing the maneuver using the second planner. In some cases, the process 500 can include switching from the second planner to the first planner (or another planner) after performing the maneuver and/or in response to detecting another trigger for switching to the first planner.

FIG. 6 illustrates an example processor-based system with which some aspects of the subject technology can be implemented. For example, processor-based system 600 can be any computing device making up local computing device 110, remote computing system 190, a passenger device (e.g., client computing device 160) executing the ridehailing application 162, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some aspects, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: determine, based on sensor data from one or more sensors of an autonomous vehicle (AV), a maneuver to be performed by the AV according to one or more parameters that deviate from one or more restrictions of a first planner being used by the AV to navigate a scene; identify a second planner of the AV that supports the one or more parameters that deviate from the one or more restrictions of the first planner; determine a state of the AV selected to trigger a switch from the first planner to the second planner; maneuver the AV using the first planner until the state of the AV is satisfied; and in response to determining that the state of the AV is satisfied, autonomously switch from the first planner to the second planner.

Aspect 2. The system of Aspect 1, wherein the first planner is configured to navigate scenes containing lanes defined with lane boundaries, wherein the second planner is configured to perform the maneuver.

Aspect 3. The system of any of Aspects 1 or 2, wherein the maneuver comprises navigating other scenes that do not contain lanes defined with lane boundaries, a parking maneuver, and/or navigating the AV around a cul-de-sac.

Aspect 4. The system of any of Aspects 1 to 3, wherein the state of the AV comprises a particular location of the AV within the scene and/or a particular pose of the AV within the scene, and wherein maneuvering the AV using the first planner until the state of the AV is satisfied comprises navigating the AV to the particular location of the AV and/or the particular pose of the AV using the first planner.

Aspect 5. The system of any of Aspects 1 to 4, wherein the one or more restrictions of the first planner comprise a collision buffer restriction that defines a minimum distance that the AV needs to maintain from other vehicles, and wherein the one or more parameters supported by the second planner allow the AV to reach or maintain a distance from other vehicles that is less than the minimum distance defined by the collision buffer restriction of the first planner.

Aspect 6. The system of claim 5, wherein identifying the second planner comprises: determining, based on at least one of the maneuver to be performed according to the one or more parameters and a context of the AV, that the AV needs to deviate from the one or more restrictions of the first planner when performing the maneuver; determining that the second planner of the AV supports the maneuver and the one or more parameters that deviate from the one or more restrictions of the first planner; and in response to determining that the AV needs to deviate from the one or more restrictions of the first planner and determining that the second planner supports the maneuver and the one or more parameters that deviate from the one or more restrictions of the first planner, selecting to use the second planner to perform the maneuver.

Aspect 7. The system of any of Aspects 1 to 6, wherein determining the state of the AV selected to trigger the switch to the second planner comprises: determining a position that the AV needs to achieve to perform the maneuver as a single maneuver from a particular position of the AV prior to performing the single maneuver; and determining the state of the AV based on the position that the AV needs to achieve to perform the maneuver as the single maneuver from particular position of the AV prior to performing the single maneuver.

Aspect 8. The system of any of Aspects 1 to 6, wherein determining the state of the AV selected to trigger the switch to the second planner comprises: determining a position that the AV needs to achieve to perform the maneuver as a continuous sequence of maneuvers from a particular position of the AV prior to performing the sequence of maneuvers; and determining the state of the AV based on the position that the AV needs to achieve to perform the maneuver as the continuous sequence of maneuvers from particular position of the AV prior to performing the sequence of maneuvers.

Aspect 9. The system of any of Aspects 1 to 8, wherein the one or more processors are configured to: after switching to the second planner, perform the maneuver using the second planner.

Aspect 10. The system of any of Aspects 1 to 9, wherein the one or more processors are configured to: after performing the maneuver using the second planner, automatically switch from the second planner to a different planner comprising the first planner or a third planner.

Aspect 11. A method comprising: determining, based on sensor data from one or more sensors of an autonomous vehicle (AV), a maneuver to be performed by the AV according to one or more parameters that deviate from one or more restrictions of a first planner being used by the AV to navigate a scene; identifying a second planner of the AV that supports the one or more parameters that deviate from the one or more restrictions of the first planner; determining a state of the AV selected to trigger a switch from the first planner to the second planner; maneuvering the AV using the first planner until the state of the AV is satisfied; and in response to determining that the state of the AV is satisfied, autonomously switching from the first planner to the second planner.

Aspect 12. The method of Aspect 11, wherein the first planner is configured to navigate scenes containing lanes defined with lane boundaries.

Aspect 13. The method of any of Aspects 11 or 12, wherein the second planner is configured to perform the maneuver.

Aspect 14. The method of any of Aspects 11 to 13, wherein the maneuver comprises navigating other scenes that do not contain lanes defined with lane boundaries, a parking maneuver, and/or navigating the AV around a cul-de-sac.

Aspect 15. The method of any of Aspects 11 to 14, wherein the state of the AV comprises a particular location of the AV within the scene and a particular pose of the AV within the scene.

Aspect 16. The method of Aspect 15, wherein maneuvering the AV using the first planner until the state of the AV is satisfied comprises navigating the AV to the particular location of the AV and/or the particular pose of the AV using the first planner.

Aspect 17. The method of any of Aspects 11 to 16, wherein the one or more restrictions of the first planner comprise a collision buffer restriction that defines a minimum distance that the AV needs to maintain from other vehicles, wherein the one or more parameters supported by the second planner allow the AV to reach or maintain a distance from other vehicles that is less than the minimum distance defined by the collision buffer restriction of the first planner.

Aspect 18. The method of Aspect 17, further comprising: determining, based on the maneuver to be performed according to the one or more parameters and/or a context of the AV, that the AV needs to deviate from the one or more restrictions of the first planner when performing the maneuver; determining that the second planner of the AV supports the maneuver and the one or more parameters that deviate from the one or more restrictions of the first planner; and in response to determining that the AV needs to deviate from the one or more restrictions of the first planner and determining that the second planner supports the maneuver and the one or more parameters that deviate from the one or more restrictions of the first planner, selecting to use the second planner to perform the maneuver.

Aspect 19. The method of any of Aspects 11 to 18, wherein determining the state of the AV selected to trigger the switch to the second planner comprises: determining a position that the AV needs to achieve to perform the maneuver from the position of the AV as a single maneuver; and determining the state of the AV based on the position that the AV needs to achieve to perform the maneuver from the position of the AV as the single maneuver.

Aspect 20. The method of any of Aspects 11 to 18, wherein determining the state of the AV selected to trigger the switch to the second planner comprises: determining a position that the AV needs to achieve to perform the maneuver from the position of the AV as a continuous sequence of maneuvers; and determining the state of the AV based on the position that the AV needs to achieve to perform the maneuver from the position of the AV as the continuous sequence of maneuvers.

Aspect 21. The method of any of Aspects 11 to 20, wherein the one or more processors are configured to: after switching to the second planner, performing the maneuver using the second planner.

Aspect 22. The method of any of Aspects 11 to 21, wherein the one or more processors are configured to: after performing the maneuver using the second planner, automatically switch from the second planner to a different planner comprising the first planner or a third planner.

Aspect 23. A non-transitory computer-readable medium having stored thereon instructions which, when executed by one or more processors, cause the one or more processors to perform a method according to any of Aspects 11 to 22.

Aspect 24. A computer-program product having stored thereon instructions which, when executed by one or more processors, cause the one or more processors to perform a method according to any of Aspects 11 to 22.

Aspect 25. A system comprising means for performing a method according to any of Aspects 11 to 22.

Aspect 26. An autonomous vehicle comprising a computing device configured to perform a method according to any of Aspects 11 to 22.

Aspect 27. An autonomous vehicle comprising means for performing a method according to any of Aspects 11 to 22.

What is claimed is:

1. A system comprising:
a memory; and
one or more processors coupled to the memory, the one or more processors being configured to:
determine, based on sensor data from one or more sensors of an autonomous vehicle (AV), a maneuver to be performed by the AV according to one or more parameters that deviate from one or more restrictions of a first planner being used by the AV to navigate a scene;
identify a second planner of the AV that supports the one or more parameters that deviate from the one or more restrictions of the first planner;
determine a state of the AV selected to trigger a switch from the first planner to the second planner;
maneuver the AV using the first planner until the state of the AV is satisfied; and
in response to determining that the state of the AV is satisfied, autonomously switch from the first planner to the second planner.

2. The system of claim 1, wherein the first planner is configured to navigate scenes containing lanes defined with lane boundaries, wherein the second planner is configured to perform the maneuver, and wherein the maneuver comprises at least one of navigating other scenes that do not contain lanes defined with lane boundaries, a parking maneuver, and navigating the AV around a cul-de-sac.

3. The system of claim 1, wherein the state of the AV comprises at least one of a particular location of the AV within the scene and a particular pose of the AV within the scene, and wherein maneuvering the AV using the first planner until the state of the AV is satisfied comprises navigating the AV to at least one of the particular location of the AV and the particular pose of the AV using the first planner.

4. The system of claim 1, wherein the one or more restrictions of the first planner comprise a collision buffer restriction that defines a minimum distance that the AV needs to maintain from other vehicles, and wherein the one or more parameters supported by the second planner allow the AV to reach or maintain a distance from other vehicles that is less than the minimum distance defined by the collision buffer restriction of the first planner.

5. The system of claim 4, wherein identifying the second planner comprises:
determining, based on at least one of the maneuver to be performed according to the one or more parameters and a context of the AV, that the AV needs to deviate from the one or more restrictions of the first planner when performing the maneuver;
determining that the second planner of the AV supports the maneuver and the one or more parameters that deviate from the one or more restrictions of the first planner; and
in response to determining that the AV needs to deviate from the one or more restrictions of the first planner and determining that the second planner supports the maneuver and the one or more parameters that deviate from the one or more restrictions of the first planner, selecting to use the second planner to perform the maneuver.

6. The system of claim 1, wherein determining the state of the AV selected to trigger the switch to the second planner comprises:
determining a position that the AV needs to achieve to perform the maneuver as a single maneuver from a particular position of the AV prior to performing the single maneuver; and
determining the state of the AV based on the position that the AV needs to achieve to perform the maneuver as the single maneuver from particular position of the AV prior to performing the single maneuver.

7. The system of claim 1, wherein determining the state of the AV selected to trigger the switch to the second planner comprises:
determining a position that the AV needs to achieve to perform the maneuver as a continuous sequence of maneuvers from a particular position of the AV prior to performing the sequence of maneuvers; and
determining the state of the AV based on the position that the AV needs to achieve to perform the maneuver as the continuous sequence of maneuvers from particular position of the AV prior to performing the sequence of maneuvers.

8. The system of claim 1, wherein the one or more processors are configured to:
after switching to the second planner, perform the maneuver using the second planner.

9. A method comprising:
determining, based on sensor data from one or more sensors of an autonomous vehicle (AV), a maneuver to be performed by the AV according to one or more parameters that deviate from one or more restrictions of a first planner being used by the AV to navigate a scene;
identifying a second planner of the AV that supports the one or more parameters that deviate from the one or more restrictions of the first planner;
determining a state of the AV selected to trigger a switch from the first planner to the second planner;
maneuvering the AV using the first planner until the state of the AV is satisfied; and
in response to determining that the state of the AV is satisfied, autonomously switching from the first planner to the second planner.

10. The method of claim 9, wherein the first planner is configured to navigate scenes containing lanes defined with lane boundaries, wherein the second planner is configured to perform the maneuver, and wherein the maneuver comprises at least one of navigating other scenes that do not contain lanes defined with lane boundaries, a parking maneuver, and navigating the AV around a cul-de-sac.

11. The method of claim 9, wherein the state of the AV comprises at least one of a particular location of the AV within the scene and a particular pose of the AV within the scene, and wherein maneuvering the AV using the first planner until the state of the AV is satisfied comprises navigating the AV to at least one of the particular location of the AV and the particular pose of the AV using the first planner.

12. The method of claim 9, wherein the one or more restrictions of the first planner comprise a collision buffer restriction that defines a minimum distance that the AV needs to maintain from other vehicles, wherein the one or more parameters supported by the second planner allow the AV to reach or maintain a distance from other vehicles where the distance is less than the minimum distance defined by the collision buffer restriction of the first planner.

13. The method of claim 12, wherein identifying the second planner comprises:
determining, based on at least one of the maneuver to be performed according to the one or more parameters and a context of the AV, that the AV needs to deviate from the one or more restrictions of the first planner when performing the maneuver;
determining that the second planner of the AV supports the maneuver and the one or more parameters that deviate from the one or more restrictions of the first planner; and
in response to determining that the AV needs to deviate from the one or more restrictions of the first planner and determining that the second planner supports the maneuver and the one or more parameters that deviate from the one or more restrictions of the first planner, selecting to use the second planner to perform the maneuver.

14. The method of claim 9, wherein determining the state of the AV selected to trigger the switch to the second planner comprises:
determining a position that the AV needs to achieve to perform the maneuver from the position of the AV as a single maneuver; and
determining the state of the AV based on the position that the AV needs to achieve to perform the maneuver from the position of the AV as the single maneuver.

15. The method of claim 9, wherein determining the state of the AV selected to trigger the switch to the second planner comprises:
determining a position that the AV needs to achieve to perform the maneuver from the position of the AV as a continuous sequence of maneuvers; and
determining the state of the AV based on the position that the AV needs to achieve to perform the maneuver from the position of the AV as the continuous sequence of maneuvers.

16. The method of claim 9, wherein the one or more processors are configured to:
after switching to the second planner, performing the maneuver using the second planner.

17. A non-transitory computer-readable medium having stored thereon instructions which, when executed by one or more processors, cause the one or more processors to:
determine, based on sensor data from one or more sensors of an autonomous vehicle (AV), a maneuver to be performed by the AV according to one or more parameters that deviate from one or more restrictions of a first planner being used by the AV to navigate a scene;
identify a second planner of the AV that supports the one or more parameters that deviate from the one or more restrictions of the first planner;
determine a state of the AV selected to trigger a switch from the first planner to the second planner;
maneuver the AV using the first planner until the state of the AV is satisfied; and
in response to determining that the state of the AV is satisfied, autonomously switch from the first planner to the second planner.

18. The non-transitory computer-readable medium of claim 17, wherein the first planner is configured to navigate scenes containing lanes defined with lane boundaries, wherein the second planner is configured to perform the maneuver, and wherein the maneuver comprises at least one of navigating other scenes that do not contain lanes defined with lane boundaries, a parking maneuver, and navigating the AV around a cul-de-sac.

19. The non-transitory computer-readable medium of claim 17, wherein the state of the AV comprises at least one of a particular location of the AV within the scene and a particular pose of the AV within the scene, and wherein maneuvering the AV using the first planner until the state of the AV is satisfied comprises navigating the AV to at least one of the particular location of the AV and the particular pose of the AV using the first planner.

20. The non-transitory computer-readable medium of claim 17, wherein the one or more restrictions of the first planner comprise a collision buffer restriction that defines a minimum distance that the AV needs to maintain from other vehicles, wherein the one or more parameters supported by the second planner allow the AV to reach or maintain a distance from other vehicles that is less than the minimum distance defined by the collision buffer restriction of the first planner.
